(19) United States
(12) Patent Application Publication
(10) Pub. No.: US 2026/0197410 A1
(43) Pub. Date: Jul. 9, 2026

(54) APPARATUS, PRINTING APPARATUS, METHOD, AND STORAGE MEDIUM

(71) Applicant: CANON KABUSHIKI KAISHA, Tokyo (JP)

(72) Inventor: TOSHIHIKO IIDA, Ibaraki (JP)

(21) Appl. No.: 19/437,015

(22) Filed: Dec. 30, 2025

(30) Foreign Application Priority Data
Jan. 7, 2025 (JP) 2025-002415

(51) Int. Cl. H04N 1/00

(52) U.S. Cl. CPC H04N 1/00726; H04N 1/00376; H04N 1/0044; H04N 1/00771; H04N 1/00779; H04N 2201/0094

(57) ABSTRACT

A multifunction peripheral (MFP) displays paper attributes whose values are not successfully determined because there is no association or slight association with paper features obtained based on detection results of a media sensor in a manner distinguishable from other paper attributes.

### BACKGROUND

### Field of the Technology

The aspect of the embodiments relates to an apparatus, a printing apparatus, a method, and a storage medium.

### Description of the Related Art

Japanese Patent Laid-Open No. 2010-217742 describes automatic detection of sheet features by providing a sensor (hereinafter, also referred to as a media sensor) for detecting physical quantities corresponding to the sheet features in an image forming apparatus.

However, the technique described in Japanese Patent Laid-Open No. 2010-217742 is predicated on that the sheet features are always successfully identified based on the detection results of the media sensor. If, for example, some sheet features are not identified based on the detection results of the media sensor, users may have difficulty in figuring out which features are identified based on the detection results of the media sensor. This makes it difficult to improve user convenience in figuring out the features of sheets to be used for printing based on the detection results of the media sensor.

### SUMMARY

According to an aspect of the embodiments, an apparatus includes at least one memory storing instructions, and at least one processor that, upon execution of the stored instructions, configures the at least one processor to operate as: an identification unit configured to identify a feature of a sheet to be used for printing, and a display control unit configured to display sheet information including the feature of the sheet on a display device, wherein the display control unit is configured to display the sheet information including features of the sheet identified by the identification unit using respective different identification methods on the display device in a mutually distinguished manner, and wherein the identification methods for the features of the sheet by the identification unit include an identification method based on a detection result of a detection unit configured to detect a physical quantity corresponding to a feature of the sheet during conveyance of the sheet.

A printing apparatus according to the aspect of the embodiments, includes the processing apparatus, a feed unit configured to feed a sheet, and a printing unit configured to form an image on the sheet.

Features of the disclosure will become apparent from the following description of embodiments with reference to the attached drawings. The following description of embodiments is described by way of example.

### BRIEF DESCRIPTION OF THE DRAWINGS

FIG. 1 is a diagram illustrating a print processing system.

FIG. 2 is a block diagram illustrating a configuration of a multifunction peripheral (MFP).

FIG. 3 is a block diagram illustrating a configuration of a digital front end (DFE).

FIG. 4A is a diagram illustrating a sheet conveyance path.

FIG. 4B is a diagram illustrating a configuration of a media sensor.

FIG. 5 is a flowchart illustrating a first example of processing in registering paper information.

FIGS. 6A and 6B are diagrams illustrating screens for performing operations to instruct registration of paper information.

FIG. 7 is a diagram illustrating paper information.

FIGS. 8A, 8B, and 8C are diagrams illustrating a paper information registration/editing screen.

FIGS. 9A, 9B, and 9C are diagrams illustrating a first example of a screen for changing a paper attribute value.

FIG. 10 is a flowchart illustrating processing in changing a paper attribute value.

FIG. 11 is a flowchart illustrating a first example of processing in changing paper information.

FIG. 12 is a diagram illustrating a paper feed unit setting screen.

FIG. 13 is a flowchart illustrating a second example of the processing in registering paper information.

FIGS. 14A and 14B are diagrams illustrating a second example of a screen for changing paper attribute values.

FIG. 15 is a flowchart illustrating a second example of the processing in changing paper information.

### DESCRIPTION OF THE EMBODIMENTS

Embodiments will be described below with reference to the drawings. Note that the following embodiments are not intended to limit the disclosure. All combinations of features described in the following embodiments are not necessarily essential to the solving means of the disclosure.

In the following embodiments, a sensor that detects physical quantities corresponding to sheet features will also be referred to as a media sensor. The following embodiments deal with a case where the sheets are sheets of paper.

However, the sheets are not limited to sheets of paper. Examples of sheets may include other paper items (such as envelopes), plastic films such as overhead projector (OHP) sheets, and fabric. In the description of the embodiments, paper may be replaced with such sheets.

In the following embodiments, paper features expressed as parameters for an image forming apparatus to use for printing and the like may be referred to as paper attributes where needed. Paper attributes include ones that can be generated based on the detection results of the media sensor and ones not. The reason is that the paper features include ones that are not associated or slightly associated with sheet features obtained based on the detection results of the media sensor. In the following embodiments, a set of paper attributes related to a sheet of paper will be referred to as paper information where needed.

### First Embodiment

A first embodiment will initially be described.

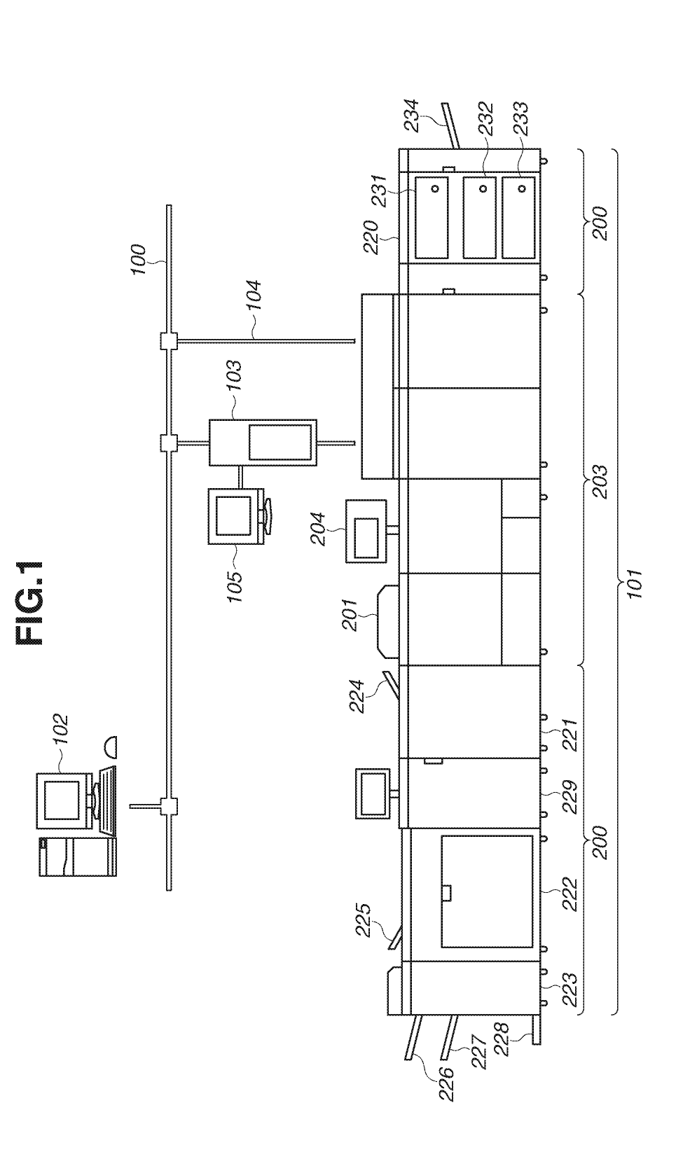

FIG. 1 is a diagram illustrating an example of a print processing system according to the embodiment. FIG. 1 illustrates a case where a multifunction peripheral (MFP) 101 and a personal computer (PC) 102 are mutually communicatively connected via a network 100. The embodiment deals with a case where the MFP 101 is an image forming apparatus and a processing apparatus. However, other apparatuses may have some of the functions of the image forming apparatus and the processing apparatus. The processing apparatus does not need to include a configuration for forming images. In such a case, the processing of the embodiment to be described below may be implemented through mutual communication of the processing apparatus and an apparatus that forms images.

FIG. 1 illustrates a case where the print processing system includes one information processing apparatus (in the example illustrated in FIG. 1, the PC 102). However, the number of information processing apparatuses included in the print processing system is not limited to one. For example, the image forming apparatus (in the example illustrated in FIG. 1, the MFP 101) and a plurality of information processing apparatuses may be mutually communicatively connected via the network 100. FIG. 1 illustrates a case where the print processing system includes the image forming apparatus and the information processing apparatus. However, the print processing system is not limited to a system that includes both the image forming apparatus and the information processing apparatus. For example, the image forming apparatus may be regarded as a print processing system. If the image forming apparatus performs singly executable image forming processing, the information processing apparatus connected to the network 100 may be omitted. Examples of the image forming processing singly executable by the image forming apparatus include printing of copy jobs and stored jobs.

An example of the PC 102 will initially be described. The PC 102 can execute various programs, including application programs. Various application programs such as a printer driver and workflow software are installed on the PC 102. The printer driver has a function of converting print data into a printer language compatible with the MFP 101. A user who wishes to print can issue print instructions by making input operations on a graphical user interface (GUI) displayed through the processing of the printer driver. Using the printer driver, workflow software, and the like, the PC 102 can convert data output from application programs based on the user's print instructions into print data interpretable by the MFP 101. The PC 102 can transmit the print data to the MFP 101 connected to the network 100.

The embodiment deals with a case where the information processing apparatus is the PC 102. However, the information processing apparatus is not limited to PCs. For example, the information processing apparatus may be a portable information terminal and the like, such as a smartphone and a tablet terminal. The method by which the information processing apparatus transmits print data to the image forming apparatus is not limited, either. For example, the information processing apparatus may transmit print data to the image forming apparatus via a printing application program or the printer driver. The information processing apparatus may transmit print data to the image forming apparatus via a cloud server.

Next, an example of the MFP 101 will be described. For example, the MFP 101 has a reading function of reading images formed on paper and a printing function of printing images on paper. The MFP 101 also has a postprocessing function. The postprocessing function implements, for example, at least one of the following: binding a plurality of sheets of paper on which images are printed, aligning a plurality of sheets of paper, and sorting sheets between multiple trays that are discharge destinations. The paper type is not limited in particular. Examples of the paper include plain paper, thick paper, and coated paper. As described above, sheets other than paper may be used.

The embodiment deals with a case where the image forming apparatus is the MFP 101. However, the image forming apparatus is not limited to MFPs. For example, the image forming apparatus may be an image forming apparatus such as a printer without a reading function.

The embodiment deals with a case where the print processing system includes a digital front end (DFE) 103. The DFE 103 is an apparatus that has at least either some of the functions of the MFP 101 or other accessory functions. In such a case, the DFE 103 can be regarded as providing the functions of the MFP 101 for the PC 102 via the network 100 instead of the MFP 101.

The DFE 103 can be accompanied with various input/output devices similar to those of the PC 102.

FIG. 1 illustrates a case where a monitor 105 that is an example of the input/output devices and the DFE 103 are mutually communicatively connected. FIG. 1 also illustrates a case where the MFP 101 and the DFE 103 are mutually communicatively connected. Even with the DFE 103 thus connected, the MFP 101 may be configured to be capable of connecting directly to the network 100 without the intermediary of the DFE 103. FIG. 1 illustrates a case where the MFP 101 is directly connected to the network 100 using a network cable 104 that is connected to the MFP 101 and the network 100. The MFP 101 may be communicatively connected to external apparatuses through wireless communication.

In the print processing system including the DFE 103, the monitor 105 may be used as a display unit and operation unit for the DFE 103. In such a case, a GUI provided by the monitor 105 may be used as one of operation units. Note that the display unit and operation unit of the DFE 103 are not limited to those using the monitor 105. For example, an operation unit 204 of the MFP 101 may be used as the operation unit of the DFE 103. At least some of the functions of the DFE 103 may be added to the MFP 101. The monitor 105 is a computer display. Examples of the computer display include a liquid crystal display and an organic electroluminescence (EL) display.

The MFP 101 includes a plurality of devices having mutually different roles. The plurality of devices is interconnected to each other. The plurality of devices enables complicated processing. Examples of the devices constituting the MFP 101 will now be described.

A printer unit 203 forms (prints) images on paper (sheets) fed from paper feed units using toner, based on image data. An example of a configuration and operation principle of the printer unit 203 will be described.

The printer unit 203 modulates and outputs a light beam (for example, laser light) based on the image data. The printer unit 203 irradiates a photosensitive drum with scanning light that is obtained by reflecting the modulated light beam with a rotating polygon mirror. The printer unit 203 develops with toner an electrostatic latent image that is formed on the photosensitive drum using this scanning light. The printer unit 203 then transfers the developed toner image to paper attached to a transfer drum. The printer unit 203 sequentially performs this series of image processing processes for each of yellow (Y), magenta (M), cyan (C), and black (K) toners. A full-color image is thereby formed on the paper.

The printer unit 203 may include a configuration capable of transferring other toners to paper in addition to the four color toners. Examples include toners of colors called special colors, and transparent toner. The paper on which the full-color image is formed on the transfer drum is conveyed to a fixing device. The fixing device includes a roller and a belt. The roller of the fixing device includes a heat source (for example, halogen heater) inside. The printer unit 203 fixes the toner on the toner image-transferred paper by melting the toner with heat and pressure in the fixing device.

The printer unit 203 also selects appropriate print speed mode and image processing mode to be applied during printing, based on features of paper to be used during the print processing.

The embodiment deals with a case where a scanner unit 201 and the operation unit 204 are located on top of the printer unit 203. The scanner unit 201 reads images formed on paper (documents), and performs image processing on image data that is data on the read images. When the processed image data is output from the scanner unit 201, the printer unit 203 forms (prints) images on paper in the manner described above based on the image data. The operation unit 204 provides various interfaces when the user performs various settings, operations, and the like of the printer unit 203.

The operation unit 204 includes a display unit and provides a GUI. The display unit included in the operation unit 204 is a computer display. Examples of the computer display includes a liquid crystal display and an organic EL display.

The embodiment deals with a case where the MFP 101 includes various devices to be described below in addition to the printer unit 203.

A large capacity paper feed device 220 is an example of a paper feed device that feeds sheets (in the embodiment, sheets of paper) to the printer unit 203. The large capacity paper feed device 220 can be detachably attached to the printer unit 203. The large capacity paper feed device 220 includes a plurality of paper feed units 231 to 234. With such a configuration, the printer unit 203 can perform print processing on large amounts of paper. FIG. 1 illustrates, as an example, a case where the paper feed units 231 to 233 are paper feed cassettes, and the paper feed unit 234 is a manual feed tray.

A sensing unit 221 reads images (for example, test chart) formed on paper by the printer unit 203, and makes various adjustments and the like based on the images. After reading the images formed on the paper, the sensing unit 221 discharges the paper to a first escape tray 224. This can prevent paper on which images such as a test chart are formed from getting mixed with output products that are the actual print products. However, the paper from which the images are read by the sensing unit 221 does not necessarily need to be discharged to the first escape tray 224. For example, the paper from which the images are read by the sensing unit 221 may be discharged to a tray of a processing device 223 to be described below.

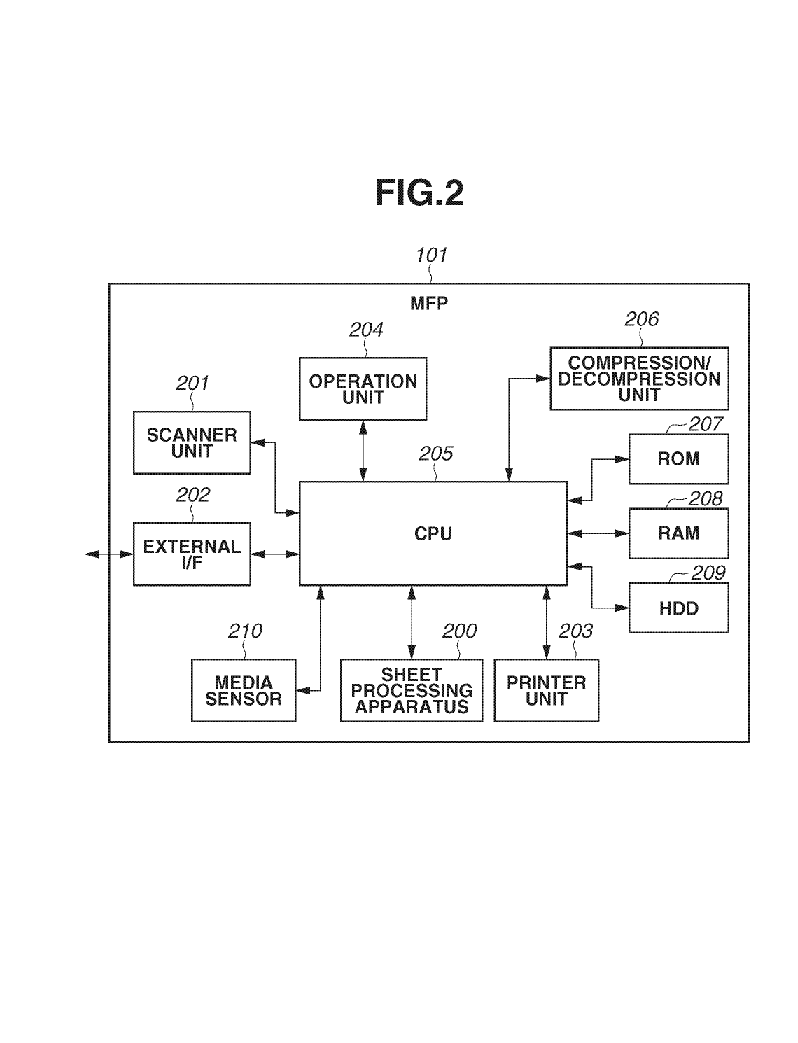

An inspection unit 229 reads images formed on print-processed paper conveyed thereto, and determines whether the images formed on the paper are normal (i.e., the presence or absence of printing failures) by comparing the images with correct images registered in advance. The correct images are also referred to as reference images. If the images formed on paper are determined to include a printing failure, the inspection unit 229 notifies a central processing unit (CPU) 205 of the identifier of the paper where the printing failure has occurred. Based on the notification, the CPU 205 performs control to discharge the paper on which the printing failure image is formed to a second escape tray 225. As will be described below with reference to FIG. 2, the CPU 205 is an example of a control unit of the MFP 101.

A stacker 222 is an output device configured so that large volumes of output products printed by the printer unit 203 can be stacked. For example, the stacker 222 includes one or more trays. In such a case, printed sheets of paper are stacked in the tray(s). The embodiment deals with a case where sheets of paper to not be stacked in the tray(s) are discharged to the second escape tray 225. As described above, paper on which a printing failure image is formed is not stacked in the tray(s) but discharged to the second escape tray 225.

The processing device 223 is a device for binding a bundle of a plurality of sheets of paper. The type of binding processing is not limited in particular. For example, the processing device 223 performs user-desired binding processing, such as corner binding, two-point binding, and saddle stitching. Bound print products are discharged to one of trays 226 to 228. For example, corner-bound or two-point-bound print products are discharge to the tray 226 or 227. For example, saddle-stitched print products are discharged to the tray 228.

The MFP 101 can be broadly divided into three sections with the printer unit 203 in the middle. In FIG. 1, the equipment on the right of the printer unit 203 is referred to as a paper feed system device. The main role of the paper feed system device is to successively feed paper loaded inside to the printer unit 203 at appropriate timing. The paper feed system device also detects the remaining level of paper loaded inside.

On the other hand, the equipment on the left of the printer unit 203 is referred to as a sheet finishing device. The equipment on the left of the printer unit 203 is also referred to as a sheet processing device or a postprocessing device. For example, the sheet finishing device performs various types of finishing and accumulation of sheets (in the embodiment, sheets of paper) on which the print processing is completed. In the following description, the foregoing paper feed system device and the sheet finishing device will be referred to collectively as a sheet processing apparatus 200 where needed.

FIG. 2 is a block diagram illustrating an example of a configuration of the MFP 101. FIG. 2 illustrates the components of the MFP 101 in units of functions. By contrast, FIG. 1 illustrates the components of the MFP 101 in units of device configuration. FIG. 2 thus includes portions that do not necessarily correspond to the components of the MFP 101 illustrated in FIG. 1.

The MFP 101 includes a nonvolatile memory such as a hard disk drive (HDD) 209. The nonvolatile memory can store data on a plurality of jobs to be processed. The nonvolatile memory is not limited to HDDs. For example, the nonvolatile memory may be a solid-state drive (SSD). The nonvolatile memory can be a mass storage device.

As described above, the scanner unit 201 reads images formed on paper, performs image processing on image data that is the data on the images, and outputs the resulting image data. The printer unit 203 performs print processing on data on the jobs to be printed, stored in the HDD 209. The operation unit 204 is an example of a user interface unit of the MFP 101. The sheet processing apparatus 200 corresponds to the foregoing paper feed system device and sheet finishing device.

The CPU 205 controls processing, operation, and the like of various devices included in the MFP 101 in a comprehensive manner. For example, the CPU 205 controls operation of the sheet processing apparatus 200 and the printer unit 203. An external interface (I/F) 202 transmits and receives data such as image data to/from external apparatuses (such as facsimiles, network-connected equipment, and external dedicated devices).

The HDD 209 stores various types of information for the MFP 101 to store permanently, as well as various types of information and the like to be changed and managed by the MFP 101.

The CPU 205 stores image data output from the scanner unit 201 in the HDD 209. The CPU 205 reads the image data stored in the HDD 209, and instructs the printer unit 203 to perform printing based on the image data. This implements the copy function of the MFP 101. The CPU 205 also stores job data received by the external I/F 202 in the HDD 209. The CPU 205 reads the job data stored in the HDD 209, and instructs the printer unit 203 to perform printing based on the job data. This implements the print function of the MFP 101. The external I/F 202 transmits various types of data to external devices based on instructions from the CPU 205. For example, the CPU 205 instructs the external I/F 202 to transmit job data read from the HDD 209 to an external device. In such a manner, the CPU 205 performs various types of input/output processing of job data to be processed, stored in the HDD 209. The MFP 101 is a multifunctional processing apparatus having such multiple functions. The MFP 101 may perform color printing or monochrome printing. The HDD 209 also stores image data compressed by a compression/decompression unit 206 to be described below.

A read-only memory (ROM) 207 stores a boot sequence, font information, and various programs such as the foregoing application programs in advance. For example, the ROM 207 stores various programs for performing processing described in the embodiment. Specifically, the programs stored in the ROM 207 include ones for performing various types of processing illustrated in flowcharts to be described below. The programs stored in the ROM 207 also include a program for performing display control to display various user interface (UI) screens on the display unit included in the operation unit 204. The programs stored in the ROM 207 also include a program for performing operations to interpret page description language data received by the external I/F 202 and render the data into raster image data (bitmap image data). The programs stored in the ROM 207 also include a program for interpreting and processing print jobs received by the external I/F 202. The embodiment deals with a case where the programs stored in the ROM 207 are executed by the CPU 205. The CPU 205 thus reads and executes the programs stored in the ROM 207, and thereby causes the components of the MFP 101 to perform various types of processing according to the embodiment.

A random access memory (RAM) 208 is a readable and writable memory. The RAM 208 temporarily stores image data transmitted from the scanner unit 201 and the external I/F 202, various programs, setting information, and the like.

The compression/decompression unit 206 compresses and decompresses image data and the like stored in the RAM 208 and the HDD 209 using various compression methods. The compression methods are not limited in particular. Examples of the compression methods include Joint Bi-Level Image Experts Group (JBIG) and Joint Photographic Experts Group (JPEG).

The media sensor 210 is a sensor for detecting physical quantities corresponding to the features (such as paper type and grammage) of paper that the MFP 101 uses when performing print processing. The embodiment exemplifies a case where the media sensor 210 is installed at a position facing the paper being conveyed through a conveyance path in the MFP 101 with a space between the sensor and the paper. An example of the arrangement of the media sensor 210 inside the MFP 101 and an example of a configuration of the media sensor 210 will be described below.

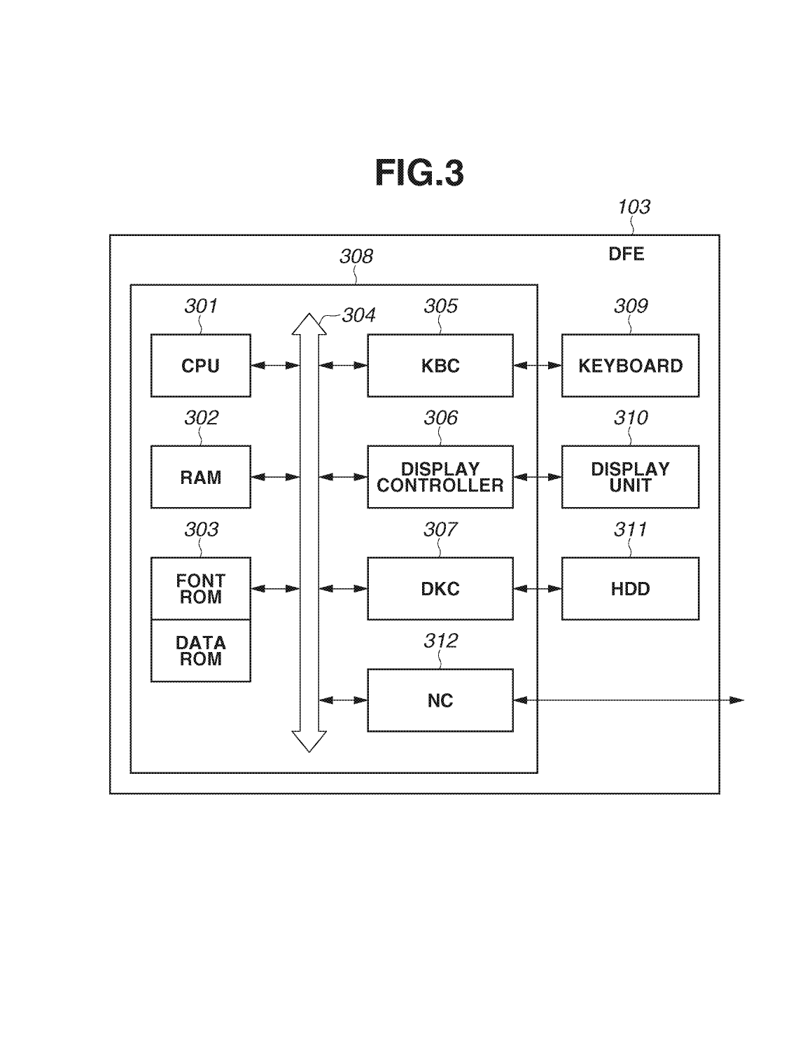

FIG. 3 is a block diagram illustrating an example of a configuration of the DFE 103.

In FIG. 3, a CPU 301 executes programs including an operating system (OS) and various application programs (for example, a bookbinding application). The software (OS, programs, and the like) to be executed by the CPU 301 is stored in at least either one of a ROM 303 and an HDD 311, for example. The CPU 301 loads software stored in the HDD 311 into a RAM 302 and executes the software. The ROM 303 includes a font ROM and a data ROM. The RAM 302 functions as a main memory, work area, and the like of the CPU 301. A keyboard controller (KBC) 305 controls input from a keyboard (KB) 309 and a pointing device (not illustrated).

A display controller 306 controls display on a display unit 310. The display unit 310 is a computer display. Examples of the computer display include a liquid crystal display and an organic EL display.

A disk controller (DKC) 307 controls access to a boot program and auxiliary storage devices such as the HDD 311. The HDD 311 stores font data, user files, and the like aside from the OS and various application programs.

A network controller (NC) 312 is connected to the network 100. The NC 312 performs processing for controlling communication with external devices connected to the network 100.

A bus 304 is connected to the CPU 301, the RAM 302, the ROM 303, the KBC 305, the display controller 306, the DKC 307, and the NC 312. The CPU 301, the RAM 302, the ROM 303, the KBC 305, the display controller 306, the DKC 307, and the NC 312 can communicate with each other via the bus 304.

For example, the CPU 301, the RAM 302, the ROM 303, the KBC 305, the display controller 306, the DKC 307, and the NC 312 transmit and receive data signals and control signals via the bus 304.

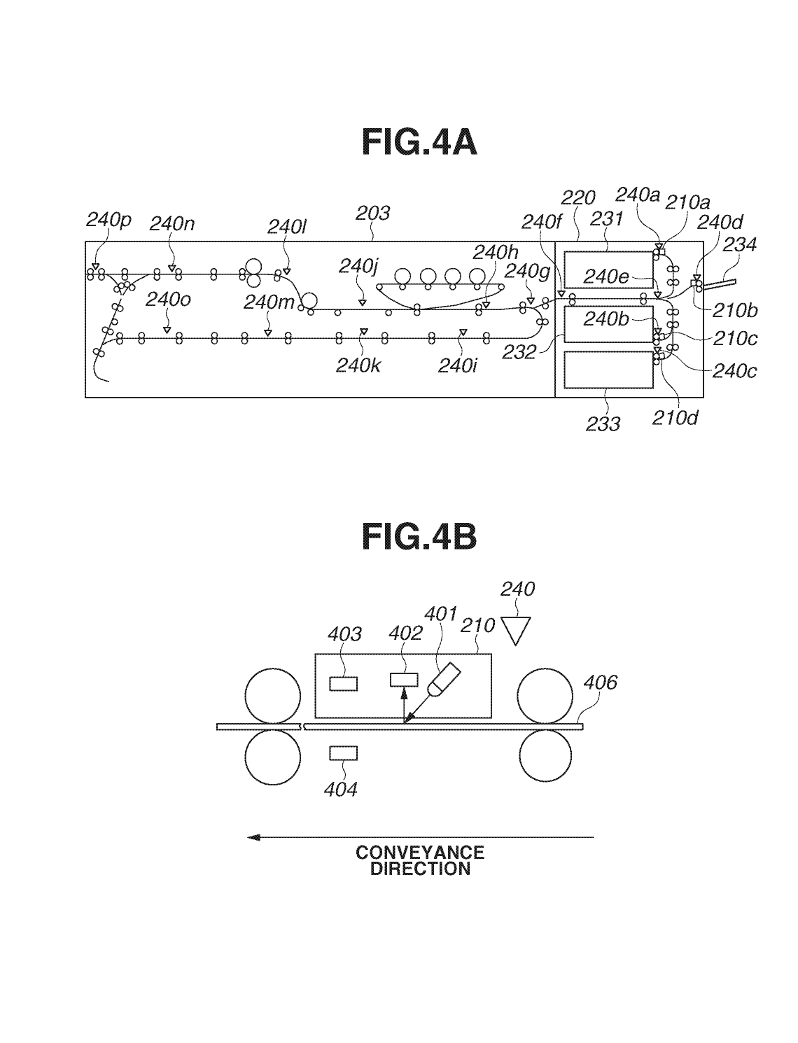

FIG. 4A is a diagram illustrating an example of paper conveyance paths.

FIG. 4A illustrates a case where media sensors 210a, 210b, 210c, and 210d are installed at positions to face paper being conveyed through locations corresponding to the outlets of the paper feed units 231, 232, 233, and 234 at a distance, respectively. To identify paper features, the paper fed from the paper feed units 231 to 234 is to be conveyed up to the positions where the media sensors 210a to 210d can detect the paper. Examples of the paper features include surface glossiness and grammage (in the following description, the surface glossiness will be referred to as a surface property where needed).

Paper detection sensors 240a to 240p detect passage of paper being conveyed through the conveyance paths. The paper detection sensors 240a to 240p are installed at positions where the paper detection sensors 240a to 240p and the paper being conveyed through the conveyance paths are opposed to each other at a distance.

The embodiment deals with a case where the media sensors 210a to 210d have the same configuration. In the following description, if the media sensors 210a to 210d are not distinguished in particular, the media sensors 210a to 210d will therefore be referred to as media sensors 210 where needed. The embodiment also deals with a case where the paper detection sensors 240a to 240p have the same configuration. In the following description, if the paper detection sensors 240a to 240p are not distinguished in particular, the paper detection sensors 240a to 240p will therefore be referred to as paper detection sensors 240 where needed.

FIG. 4B is a diagram illustrating an example of a media sensor 210. There are various forms of media sensors 210. The media sensor 210 illustrated in FIG. 4B is just an example of a sensor that detects physical quantities corresponding to features of a sheet (in the embodiment, a sheet of paper). The media sensor 210 is not limited to the media sensor 210 illustrated in FIG. 4B.

FIG. 4B illustrates a case where the media sensor 210 includes a light-emitting diode (LED) 401, a line sensor 402, a transmission unit 403, and a reception unit 404.

The paper detection sensor 240 includes an irradiation unit and a light reception unit. The irradiation unit emits light toward a paper conveyance path. If there is paper in the conveyance path, the light emitted from the irradiation unit is reflected at the paper. The light reception unit can receive the light reflected from the sheet. If the level of the light received by the light reception unit is higher than or equal to a predetermined level, the CPU 205 determines that paper is detected by the paper detection sensor 240.

If paper 406 being conveyed through a position in front of the media sensor 210 is detected by the paper detection sensor 240, the CPU 205 instructs the LED 401, the line sensor 402, the transmission unit 403, and the reception unit 404 to start measurement. If the state where paper is detected by the same paper detection sensor 240 lasts for a specific time or more, or if paper to be detected by the paper detection sensor 240 is not detected for a specific time or mover, the CPU 205 determines that a jam (paper jam) has occurred.

The LED 401 and the line sensor 402 are used to estimate (calculate) the surface property of the paper. When the paper 406 being conveyed through the position in front of the media sensor 210 is detected by the paper detection sensor 240 and the CPU 205 issues instructions to start measurement, the LED 401 irradiates the paper surface. The light emitted from the LED 401 to the paper 406 is reflected at the paper 406. When the light reflected from the paper 406 is input to pixels of the line sensor 402, the line sensor 402 outputs voltages corresponding to the luminance values of the light. The surface unevenness of the paper 406 can be calculated based on a difference between the luminance values of two adjoining pixels. The surface property of the paper 406 can be calculated based on the magnitude of the sum of the luminance values of the pixels.

The transmission unit 403 and the reception unit 404 are used to estimate (calculate) the grammage and thickness of the paper 406. The transmission unit 403 includes an element that can transmit sound waves of a predetermined frequency (for example, ultrasonic waves) based on a given signal input to the transmission unit 403. The reception unit 404 includes an element that can receive the sound waves transmitted from the transmission unit 403. The reception unit 404 outputs a reception signal based on the sound pressure of the received sound waves. When the paper 406 being conveyed through the position in front of the media sensor 210 is detected by the paper detection sensor 240 and the CPU 205 issues the instructions to start measurement, the transmission unit 403 transmits sound waves toward the surface of the paper 406. The sound waves transmitted from the transmission unit 403 are incident on the paper 406. The reception unit 404 receives sound waves passed through the paper 406. The grammage and thickness of the paper 406 can be calculated based on a difference between the level of the sound waves transmitted from the transmission unit 403 and the level of the sound waves received by the reception unit 404. Some types of paper may have nonuniform thickness. Transmitting continuous waves from the transmission unit 403 enables calculation of the unevenness in paper thickness, whereby an average grammage and thickness of the paper can also be calculated.

When the paper 406 being conveyed through the position in front of the media sensor 210 is detected by the paper detection sensor 240, the CPU 205 may start measuring the time needed to estimate (calculate) the paper features. In such a case, the CPU 205 ends measuring the time when the estimation (calculation) of the paper features is completed. The time needed to estimate (calculate) the paper features refers to a time obtained by subtracting, from the measured time, the time needed to convey the paper without estimating the paper features over the same distance as in estimating the paper features, for example.

The embodiment deals with a case where the voltage (luminance) values output from the line sensor 402 and the level of the sound waves received by the reception unit 404 are detected by the media sensor 210 as examples of the physical quantities corresponding to the features of the paper 406. The embodiment also deals with a case where the surface glossiness, grammage, and thickness of the paper 406 are estimated (calculated) by the CPU 205 as examples of the features of the paper 406, based on the detection results of the media sensor 210. For the sake of high-quality printing and the like, paper information includes many parameters (paper attributes). The paper information may also include paper attributes that are not directly used for printing but facilitate paper management by users. In the following description, the values of the physical quantities detected by the media sensor 210 will be referred to as detection values of the media sensor 210 where needed.

The embodiment deals with a case where the paper attributes estimated from the detection values of the media sensor 210 are only the surface property, grammage, and thickness of the paper. However, paper attributes to be estimated from the detection values of the media sensor 210 are not limited thereto. The CPU 205 can estimate the values (content) of paper attributes other than the surface property, grammage, and thickness of the paper based on the detection values of the media sensor 210, using various algorithms. Meanwhile, the paper information may include paper attributes that are not associated at all (or slightly associated) with the paper attributes estimated from the detection values of the media sensor 210. For example, paper color, shape, and preprint paper (such as whether the paper is preprinted) are unable to be determined (or difficult to determine) as paper attributes of appropriate values using any algorithm. Such paper attributes are to be set by users.

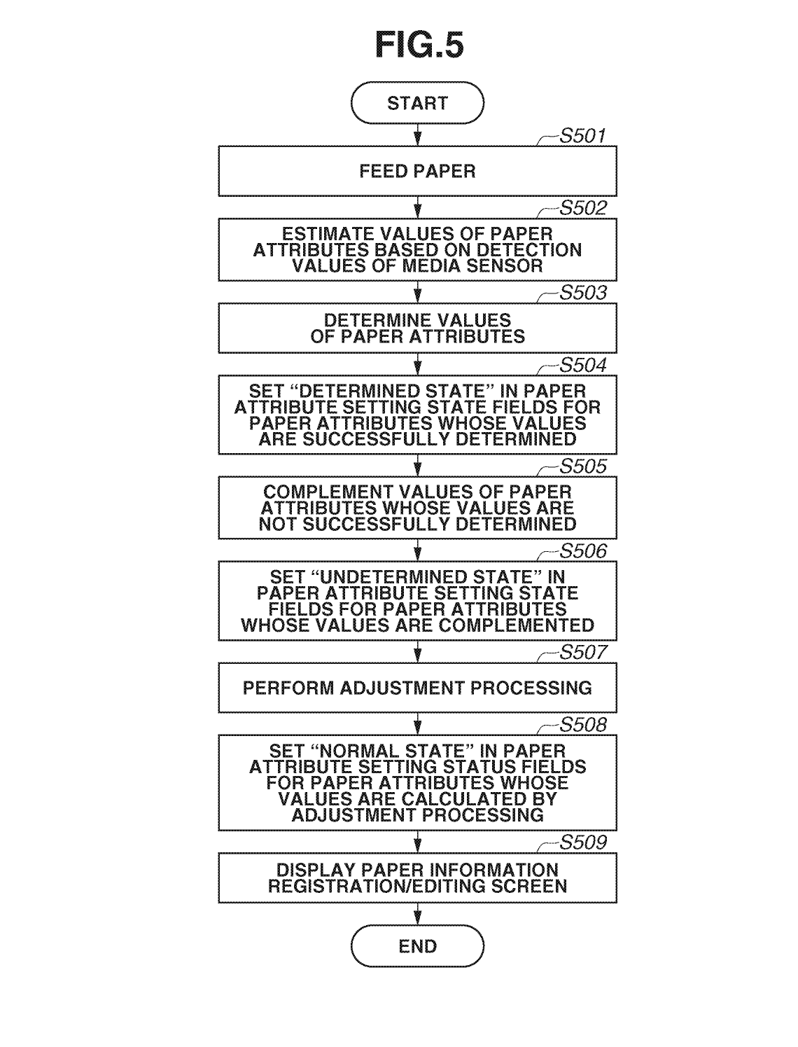

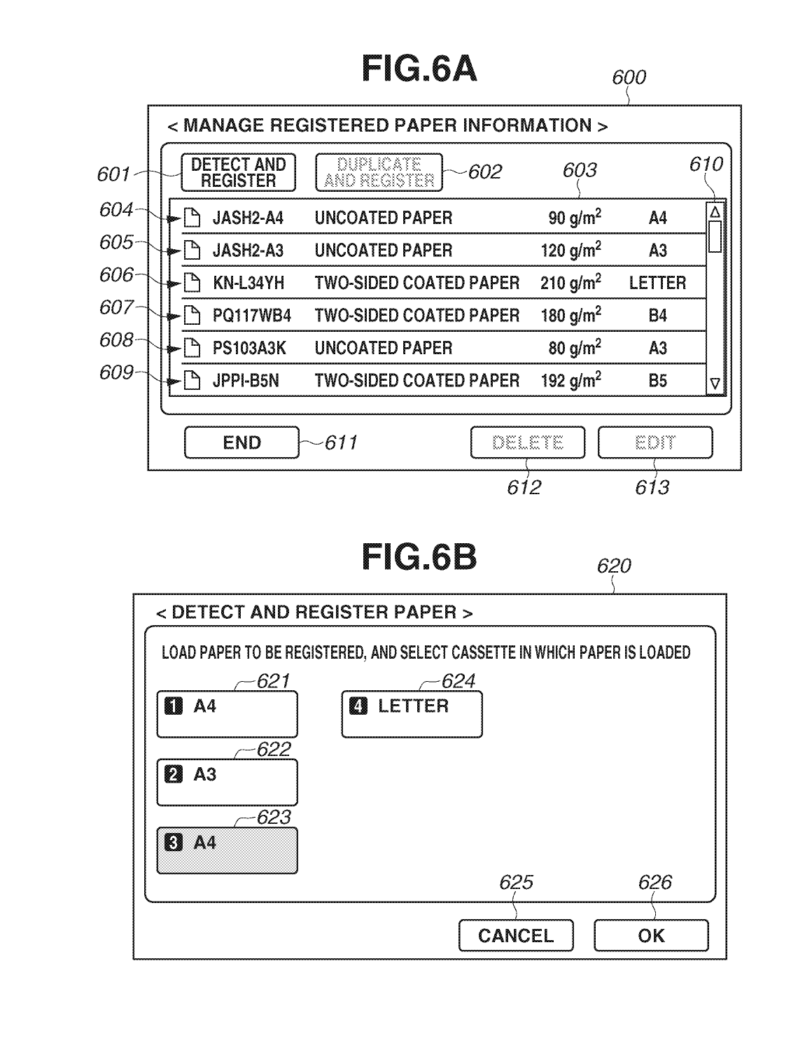

FIG. 5 is a flowchart for describing an example of processing of the MFP 101 when an instruction is given to register paper information using the media sensor 210. The flowchart of FIG. 5 starts, for example, when the user operates the operation unit 204 to instruct registration of paper information using the media sensor 210. FIGS. 6A and 6B are diagrams illustrating an example of a screen for making operations to instruct registration of paper information. FIG. 6A is a diagram illustrating an example of a paper information management screen 600. Operations for registering new paper information and for deleting or editing registered paper information are performed on the paper information management screen 600. FIG. 6B is a diagram illustrating an example of a detection paper selection screen 620. The detection paper selection screen 620 is displayed when a first registration button 601 of the paper information management screen 600 is selected. Operations for selecting paper (paper feed unit) to be used in registering new paper information based on the detection values of the media sensor 210 are performed on the detection paper selection screen 620. The embodiment deals with a case where the paper information management screen 600 and the detection paper selection screen 620 are displayed on the display unit included in the operation unit 204. However, this is not necessarily required. For example, at least one of the paper information management screen 600 and the detection paper selection screen 620 may be displayed on the display unit 310 of the DFE 103. The same applies to screens other than the paper information management screen 600 and the detection paper selection screen 620.

The user initially operates the operation unit 204 to instruct registration of new paper information. Based on this operation, the CPU 205 displays the paper information management screen 600 illustrated in FIG. 6A on the display unit included in the operation unit 204. Then, if the first registration button 601 is selected by the user, the CPU 205 displays the detection paper selection screen 620 on the display unit included in the operation unit 204. The first registration button 601 is a button to be used to register new paper information using the media sensor 210.

In FIG. 6B, detection paper selection buttons 621 to 624 are buttons for selecting paper to be used (fed) in registering new paper information. The detection paper selection buttons 621, 622, 623, and 624 correspond to the paper feed units 231, 232, 233, and 234, respectively. FIG. 6B illustrates a case where the number of buttons the user can select at a time is one. The button selected by the user among the detection paper selection buttons 621 to 624 enters a selected state. FIG. 6B illustrates a case where the detection paper selection button 623 is in the selected state. The CPU 205 stores in the RAM 208 identification information about the paper feed unit corresponding to the button selected by the user among the detection paper selection buttons 621 to 624. If one of the detection paper selection buttons 621 to 624 is in the selected state when another detection paper selection button is selected, the CPU 205 cancels the selection information about the detection paper button selected first. The CPU 205 also brings the detection paper selection button selected afterward into the selected state.

A cancel button 625 is a button for terminating the display of the detection paper selection screen 620. If the cancel button 625 is selected, the CPU 205 does not register (generate) new paper information.

An OK button 626 is a button for terminating the display of the detection paper selection screen 620.

In one embodiment, the OK button 626 becomes selectable only when one of the detection paper selection buttons 621 to 624 is in the selected state. If the OK button 626 is selected, the CPU 205 starts the processing of the flowchart of FIG. 5.

In step S501, the CPU 205 identifies the button that is in the selected state when the OK button 626 is selected, among the detection paper selection buttons 621 to 624. The CPU 205 then feeds paper from the paper feed unit corresponding to the button among the paper feed units 231 to 234.

In step S502, the CPU 205 estimates the values of paper attributes based on the detection values of the media sensor 210. The embodiment deals with a case where the surface property, grammage, and thickness of the paper 406 are estimated in step S502.

In step S503, the CPU 205 determines the values of paper attributes that can be estimated. The paper attributes whose values are determined in step S503 (the values of paper attributes that can be estimated) are the values of the paper attributes estimated from the detection values of the media sensor 210 and the values of paper attributes further estimated from the values of the paper attributes. The embodiment deals with a case where the values estimated in step S502 are simply determined to be those of the paper attributes whose values are estimated in step S502.

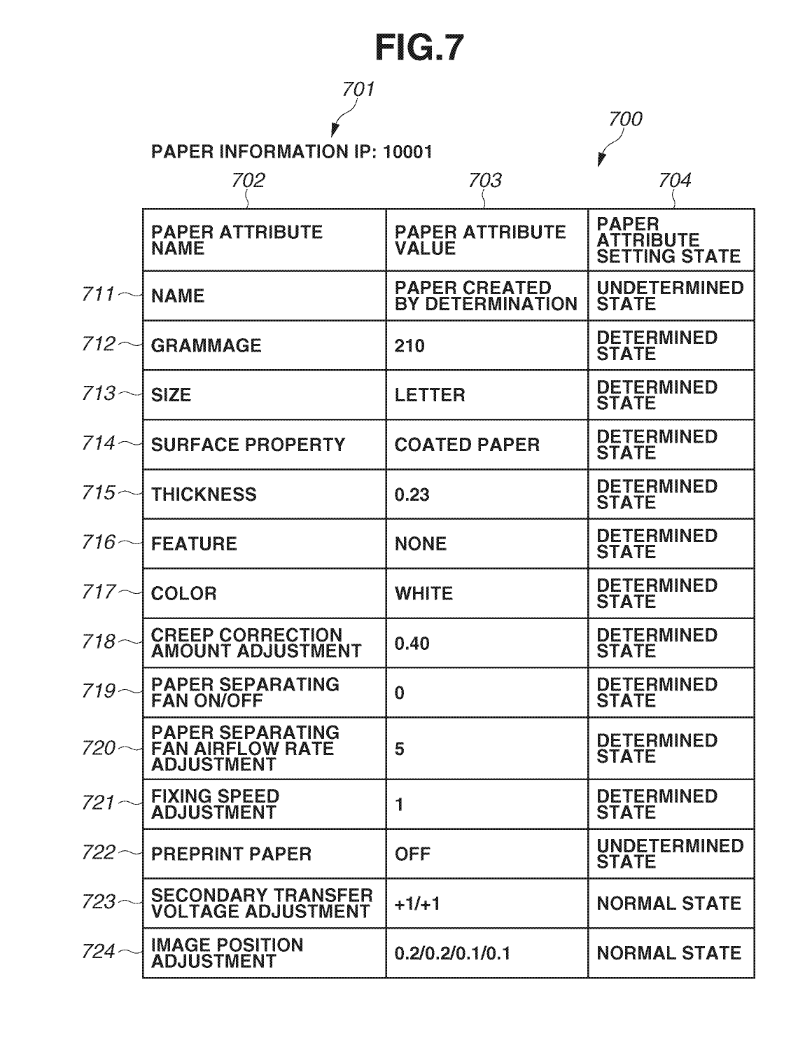

FIG. 7 is a diagram illustrating an example of paper information 700. There is a piece of paper information 700 for each type of paper for which the values of paper attributes are set based on the detection results of the media sensor 210, for example. The paper information 700 is stored in the HDD 209, for example, and copied to the RAM 208 and updated as needed. In such a case, for example, the portions of the paper information 700 updated in the RAM 208 are reflected on the paper information 700 stored in the HDD 209.

In FIG. 7, a paper information identifier (ID) 701 is an ID uniquely assigned to each piece of paper information 700. The CPU 205 can acquire a given piece of paper information from the HDD 209 based on the paper information ID 701. The CPU 205, when changing information about paper attributes included in the paper information 700, can also identify paper information that includes paper attributes whose values are to be changed among the pieces of paper information stored in the HDD 209, based on the paper information ID 701. In such a case, the CPU 205 can update the information about the paper attributes included in the identified paper information, and store the updated information.

A paper attribute name 702, a paper attribute value 703, and a paper attribute setting state 704 are columns for storing the names of paper attributes, the values of the paper attributes, and setting states of the values of the paper attributes, respectively. The information stored in these columns are used as parameters during printing, for example.

FIG. 7 illustrates a case where 14 types of paper attributes 711 to 724 are included in a single piece of paper information 700.

Details of the setting states of the paper attribute values will be described below.

As described above, the embodiment deals with a case where the paper attribute values are sheet features.

The embodiment also deals with a case where information displayed based on the content of the paper information 700 is sheet information. The embodiment also deals with a case where the setting states of the paper attribute values are information whose content depends on the method for identifying sheet features.

There are various methods for determining the paper attribute values. For example, using the values of the paper attributes estimated from the detection values of the media sensor 210, the CPU 205 may select a piece of paper information that includes paper attributes having values closest to the values of the paper attributes from a plurality of pieces of paper information registered in advance. In such a case, the CPU 205 may determine the values of paper attributes included in the selected paper information as the values of paper attributes other than those estimated from the detection values of the media sensor 210. The CPU 205 may calculate the values of paper attributes associated with the paper attributes whose values are estimated from the detection values of the media sensor 210, based on the values of the paper attributes estimated from the detection values of the media sensor 210. For example, a creep correction amount adjustment 718 is a paper attribute associated with the paper thickness. A paper separating fan airflow rate adjustment 720 is a paper attribute associated with the paper grammage. A fixing speed adjustment 721 is a paper attribute associated with the paper grammage and surface property. The values of the creep correction amount adjustment 718, the paper separating fan airflow rate adjustment 720, and the fixing speed adjustment 721 may therefore be calculated from the paper thickness, the paper grammage, and the paper grammage and surface property estimated in step S502, respectively. The methods for determining paper attributes are not limited to the foregoing usage.

In step S504, the CPU 205 sets "determined state" in the fields of the paper attribute setting state 704 corresponding to the paper attributes whose values are successfully determined in step S503.

In step S505, the CPU 205 complements the values of paper attributes whose values are not successfully determined in step S503. The embodiment deals with a case where default values are set for the respective paper attributes in advance as the values of paper attributes whose values are not successfully determined in step S503. Here, the CPU 205 complements the values of the paper attributes whose values are not successfully determined in step S503 by setting those values to default values set for the paper attributes. The embodiment deals with a case where the values of paper attributes whose values are not successfully determined in step S503 are set to the default values set for the paper attributes, whereby features not identified from the detection results of the detection unit are identified as features of predetermined content.

In step S506, the CPU 205 sets "undetermined state" in the fields of the paper attribute setting state 704 corresponding to the paper attributes whose values are not successfully determined and complemented since there is no association or slight association with the sheet attributes based on the detection values of the media sensor 210.

In step S507, the CPU 205 calculates the values of paper attributes by adjustment processing. For example, adjustment values in a secondary transfer voltage adjustment 723 and an image position adjustment 724 are calculated in the following manner. Initially, print a test chart on paper. Next, scan the test chart printed on the paper to read the printing state and position. Then, calculate the adjustment values in the secondary transfer voltage adjustment 723 and the image position adjustment 724 based on the printing state and position. By performing this adjustment processing after the paper fed for paper attribute estimation has passed through the media sensor 210, the values of the paper attributes whose values are not successfully determined in step S503 can be calculated.

In step S508, the CPU 205 sets "normal state" in the fields of the paper attribute setting state 704 corresponding to the attribute values whose values are calculated by performing the adjustment processing in step S507.

Note that the adjustment processing is not necessarily essential, and step S507 need not be performed. In the case where step S507 is not performed, the processing of steps S507 and S508 is skipped. Steps S505 and S506 and steps S507 and S508 may be performed in reverse order.

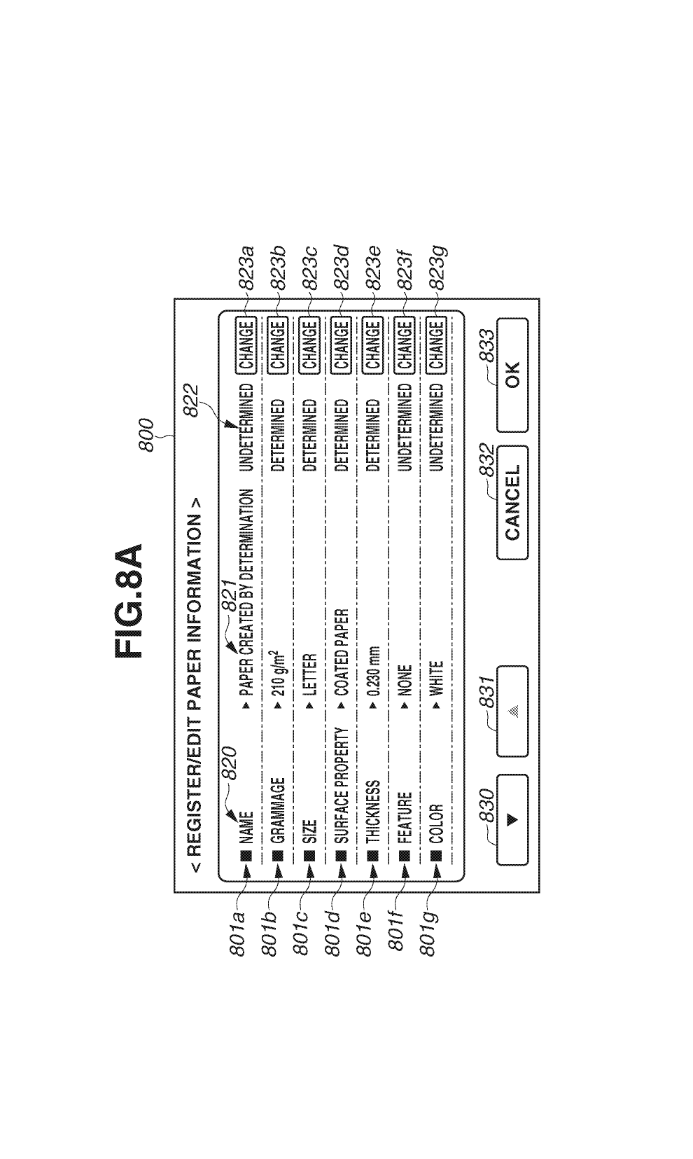

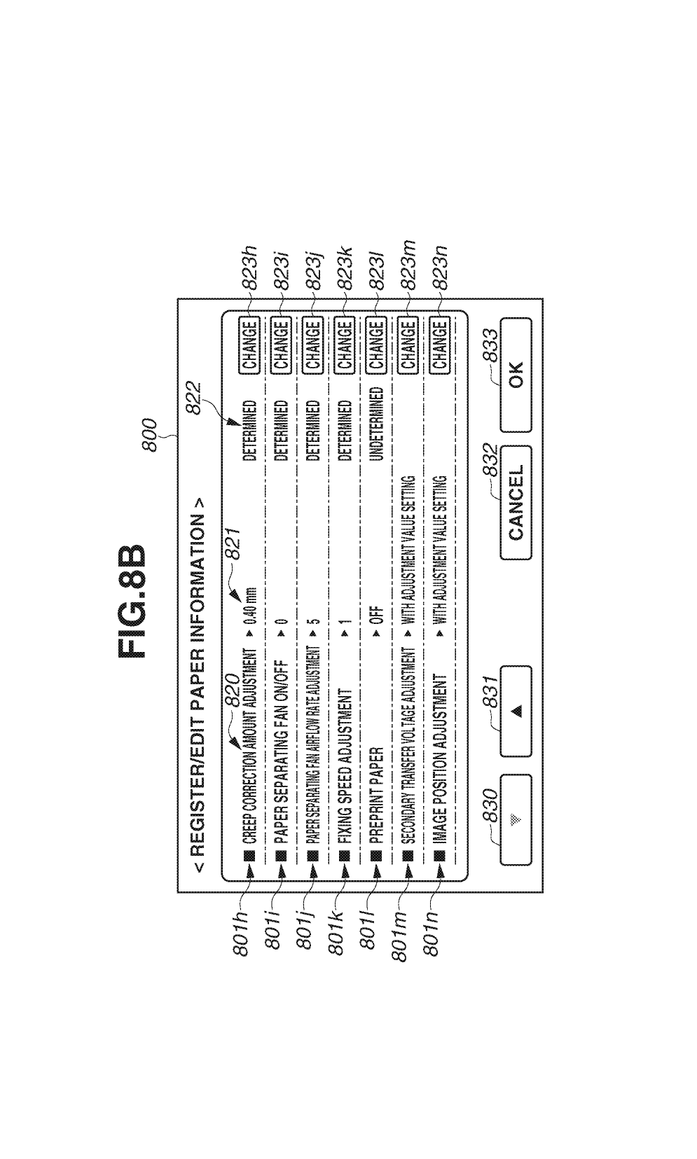

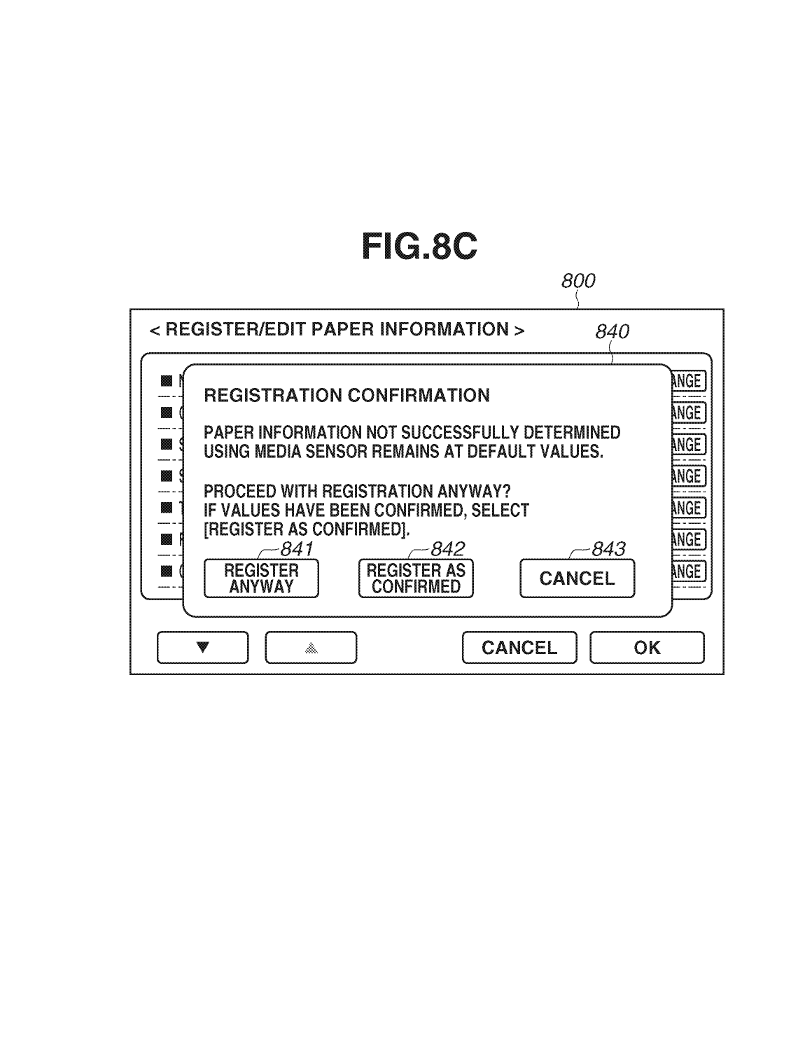

In step S509, the CPU 205 displays a paper information registration/editing screen 800 illustrated in FIGS. 8A to 8C on the display unit included in the operation unit 204. The paper information registration/editing screen 800 displays the content of the paper information obtained based on the result of the processing of steps S502 to S508. The paper information registration/editing screen 800 displays the content of the paper information so that the user can easily distinguish the paper attributes in the undetermined state and the other paper attributes.

The paper information management screen 600 illustrated in FIG. 6A will now be described.

As described above, the first registration button 601 is a button to be selected in registering new paper information. If the first registration button 601 is selected, the detection paper selection screen 620 is displayed.

The second registration button 602 is a button to be selected in duplicating already registered paper information and registering new paper information. The second registration button 602 becomes selectable when any of paper information selection buttons 604 to 609 is selected. If the second registration button 602 is selected, the CPU 205 duplicates the paper information corresponding to the button being selected at that point in time among the paper information selection buttons 604 to 609, and registers new paper information. The CPU 205 also displays the paper information registration/editing screen 800.

A registered paper information display area 603 is an area for displaying the paper information selection buttons 604 to 609. If all the paper information registered in the MFP 101 is unable to be displayed in the registered paper information display area 603 at a time, the CPU 205 displays a scrollbar 610 on the paper information management screen 600. Accepting operation on the scrollbar 610, the CPU 205 changes the paper information selection buttons to be displayed in the registered paper information display area 603.

The paper information selection buttons 604 to 609 are buttons for selecting pieces of paper information registered in the MFP 101. FIG. 6A illustrates a case where the number of buttons the user can select at a time among the paper information selection buttons 604 to 609 is one. The button selected by the user among the paper information selection buttons 604 to 609 enters a selected state. If one of the paper information selection buttons 604 to 609 is in the selected state when another paper information selection button is selected, the CPU 205 cancels the selection information about the paper information selection button selected first. The CPU 205 also brings the paper information selection button selected afterward into the selected state.

An end button 611 is a button for terminating the display of the paper information management screen 600.

If the end button 611 is selected, the CPU 205 terminates the display of the paper information management screen 600, and displays a not-illustrated screen displayed before the display of the paper information management screen 600 on the display unit included in the operation unit 204.

A delete button 612 is a button for deleting paper information registered in the MFP 101. An edit button 613 is a button for editing paper information registered in the MFP 101. The delete button 612 and the edit button 613 become selectable when one of the paper information selection buttons 604 to 609 is selected. If the delete button 612 is selected, the CPU 205 deletes the paper information 700 corresponding to the button being selected at that point in time among the paper information selection buttons 604 to 609 from the HDD 209.

If the edit button 613 is selected, the CPU 205 reads the paper information 700 corresponding to the button being selected at that point in time among the paper information selection buttons 604 to 609 from the HDD 209, and stores the paper information 700 in the RAM 208. The CPU 205 also displays the paper information registration/editing screen 800 illustrated in FIGS. 8A to 8C on the display unit included in the operation unit 204.

As described above, the embodiment deals with a case where the paper information registration/editing screen 800 illustrated in FIGS. 8A to 8C is displayed not only when the processing of step S509 is performed but also when the edit button 613 or the second registration button 602 is selected on the paper information management screen 600. The paper information registration/editing screen 800 is displayed both in the case of registering new paper information and in the case of editing paper information.

When the processing of step S509 is performed or when the second registration button 602 is selected, the paper information registration/editing screen 800 is displayed to register new paper information.

On the other hand, when the edit button 613 is selected, the paper information registration/editing screen 800 is displayed to edit already registered paper information. The paper information registration/editing screen 800 will now be described. The embodiment deals with a case where the paper information registration/editing screen 800 is displayed to provide a screen display capable of at least one of registration and editing of sheet features.

The paper information registration/editing screen 800 illustrated in FIG. 8A and the paper information registration/editing screen 800 illustrated in FIG. 8B differ in the content of paper attribute items 801a to 801n displayed. The embodiment deals with a case where if the number of paper attributes is so large that the paper attribute items 801a to 801n are unable to be displayed on a single screen, the paper attribute items 801a to 801n are displayed divided across multiple pages. The display of the paper information registration/editing screen 800 illustrated in FIG. 8A and that of the paper information registration/editing screen 800 illustrated in FIG. 8B are switched through selection of page switch buttons 830 and 831.

The fields of the paper attribute items 801a to 801n display the fields of a paper attribute name 820, the fields of a paper attribute value 821, the fields of a paper attribute setting state 822, and paper attribute change buttons 823a to 823n.

The fields of the paper attribute name 820 are areas for displaying the names of the paper attributes. The names of the paper attributes stored in the paper attribute name 702 are displayed in the fields of the paper attribute name 820.

The fields of the paper attribute value 821 are areas for displaying the values of the paper attributes. The values of the paper attributes stored in the fields of the paper attribute value 703 are displayed in the fields of the paper attribute value 821.

The fields of the paper attribute setting state 822 are areas for displaying the setting states of the paper attribute values. The information stored in the fields of the paper attribute setting state 704 illustrated in FIG. 7 is displayed in the fields of the paper attribute setting state 822. The embodiment deals with a case where text information "determined" is displayed in the fields of the paper attribute setting state 822 that correspond to the paper attributes whose values are determined based on the detection values of the media sensor 210 (see steps S502 to S504). The embodiment also deals with a case where text information "undetermined" is displayed in the fields of the paper attribute setting state 822 that correspond to the paper attributes whose appropriate values are not successfully determined (see steps S505 and S506). The embodiment also deals with a case where no information is displayed in the fields of the paper attribute setting state 822 that correspond to the paper attributes whose values are calculated by performing adjustment processing (see steps S507 and S508). The embodiment also deals with a case where no information is displayed in the fields of the paper attribute setting state 822 that correspond to the paper attributes whose values are set by user selection. That no information is displayed in a field of the paper attribute setting state 822 indicates that the setting state is the normal state. As described above, in the embodiment, the information in the fields of the paper attribute setting state 822 is changed based on changes in the paper attribute values. The embodiment deals with a case where when a sheet feature changes due to a change in the identification method of the sheet feature, the manner in which the sheet information including the changed sheet feature is distinguished from other sheet information is changed based on the changed identification method. Changing the manner of distinction from other sheet information includes situations where sheet information displayed in a manner distinguishable from other sheet information is no longer displayed in the manner distinguishable from the other information because the identification method of the sheet feature is changed. Changing the manner also includes situations where sheet information not displayed in a manner distinguishable from other sheet information is displayed in the manner distinguishable from the other sheet information because the change in the identification method of the sheet feature is changed.

The method for displaying the setting states of the paper attribute values in the fields of the paper attribute setting state 822 is not limited in particular. However, at least paper attributes in the undetermined state and ones other than in the undetermined state can be displayed in a visually easily identifiable manner to facilitate the user recognizing paper attributes that they are to set by themselves. Examples of the paper attributes other than in the undetermined state in FIGS. 8A and 8B include the grammage 801b and the secondary transfer voltage adjustment 801n. Examples of the paper attributes in the undetermined state include the paper attribute name 801a. If the values of the paper attributes in the determined state and the undetermined state are changed by the user or if the values of the paper attributes in the undetermined state are confirmed by the user, no information is displayed in the fields of the paper attribute setting state 822 corresponding to those paper attributes. As described above, FIGS. 8A and 8B illustrate a case where the text information "undetermined" is displayed in the fields of the paper attribute setting state 822 corresponding to the paper attributes for which the undetermined state is set in step S506. FIGS. 8A and 8B also illustrate a case where the text information "determined" is displayed in the fields of the paper attribute setting state 822 corresponding to the paper attributes for which the determined state is set in step S504. FIGS. 8A and 8B also illustrate a case where no information is displayed in the fields of the paper attribute setting state 822 corresponding to the paper attributes for which the normal state is set.

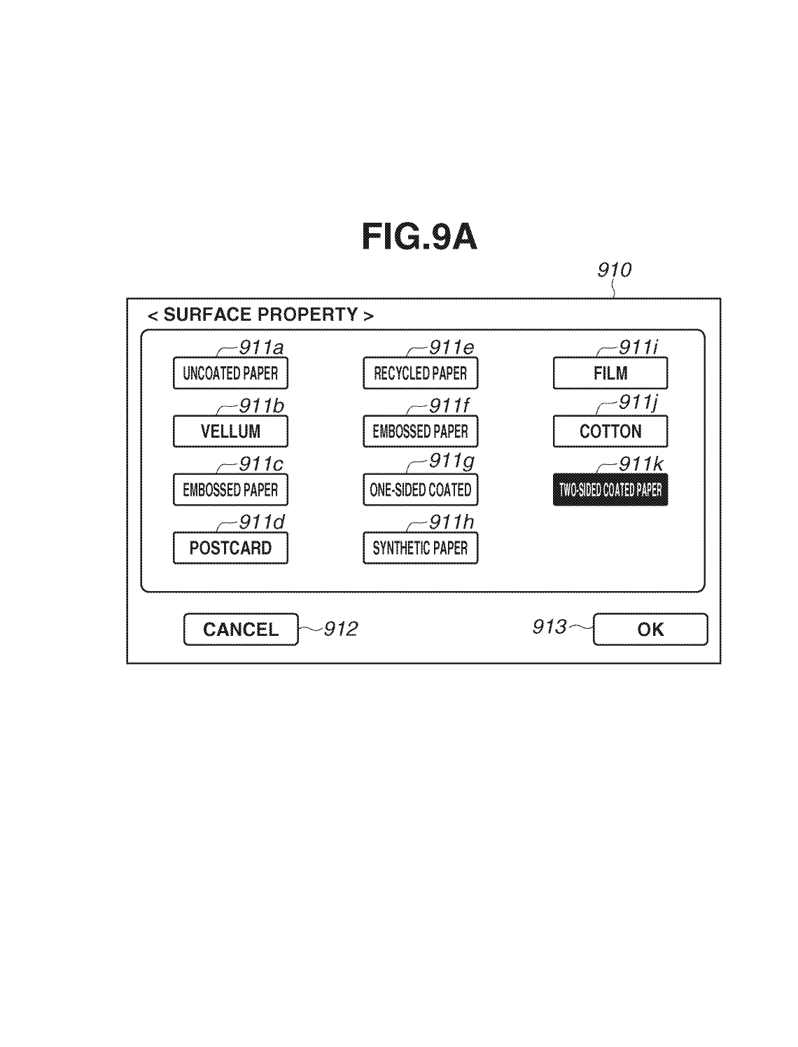

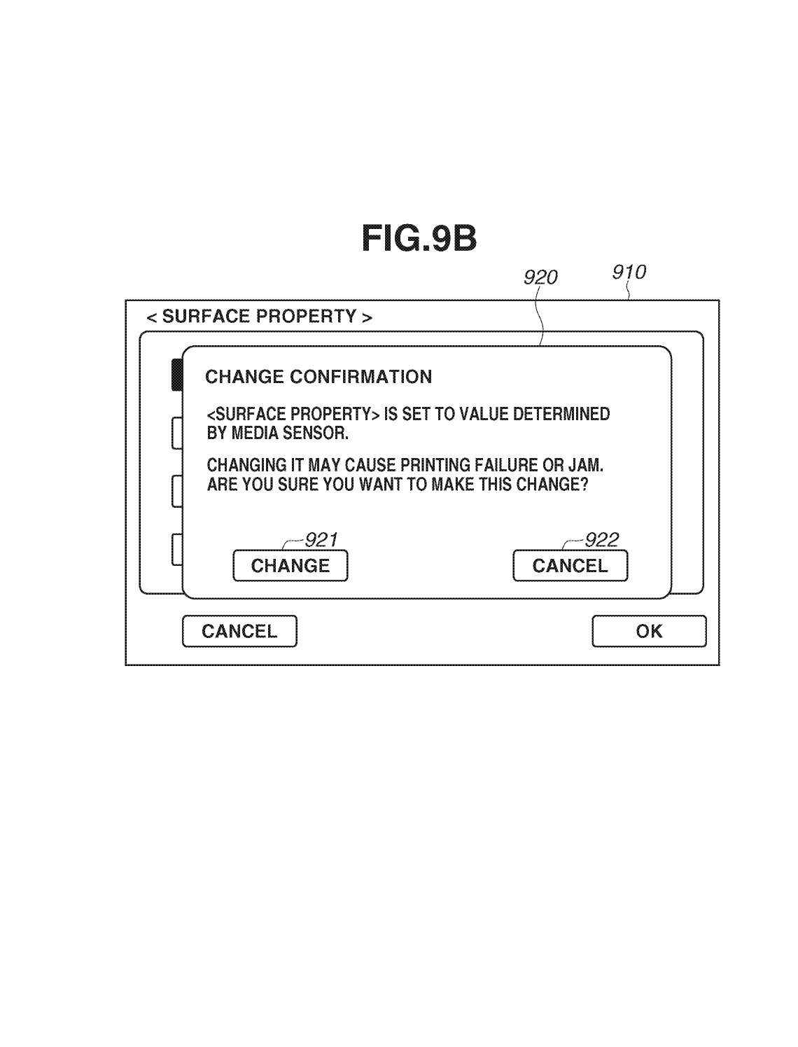

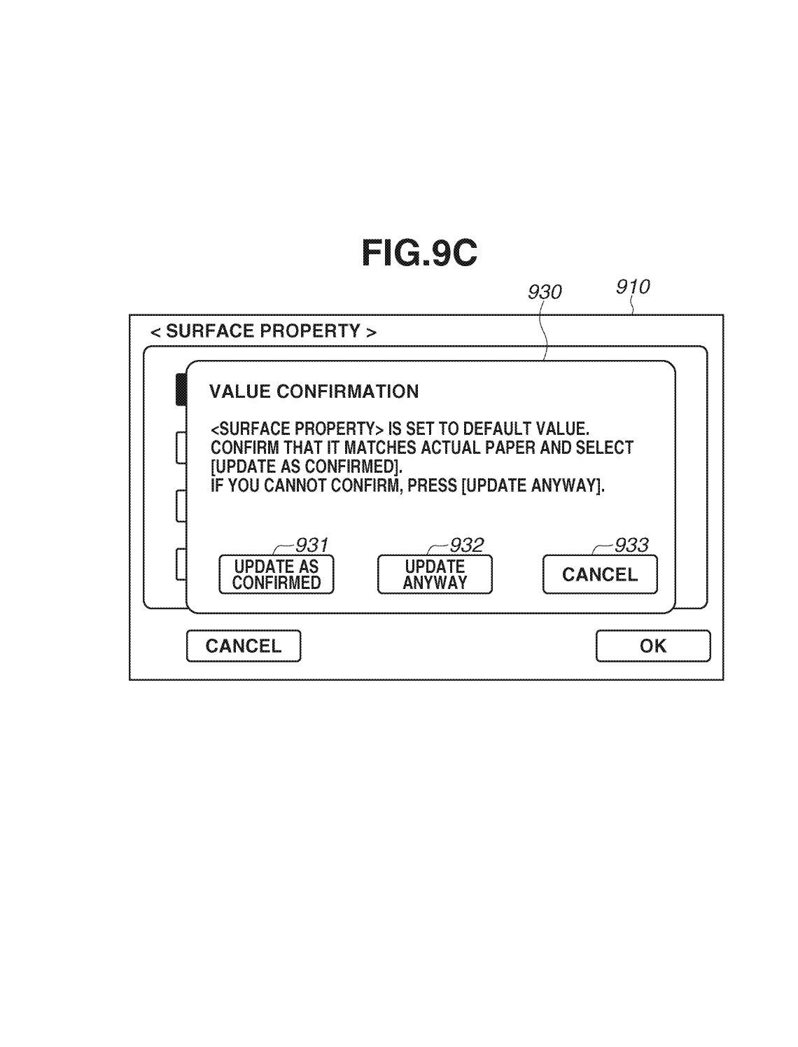

The paper attribute change buttons 823a to 823n are buttons for changing the paper attribute values displayed in the fields of the paper attribute items 801a to 801n (values stored in the fields of the paper attribute value 703). If one of the paper attribute change buttons 823a to 823n is selected, the CPU 205 displays a paper attribute change screen on the display unit included in the operation unit 204. FIG. 9A is a diagram illustrating an example of a paper attribute change screen 910. The paper attribute change screen 910 is a screen for setting or changing the paper attribute values stored in the fields of the paper attribute value 703. FIG. 9A illustrates the paper attribute change screen 901 in the case of changing the surface property of the paper, which is one of the paper attributes. The paper attribute change screen 910 here is displayed when the paper attribute change button 823d corresponding to the surface property 801d is selected in FIG. 8A.

In FIG. 9A, surface property setting buttons 911a to 911k are buttons for selecting the content of the surface property (value of the paper attribute). By selecting one of the surface property setting buttons 911a to 911k, the user can set the content displayed on the button as the content of the surface property (value of the paper attribute). FIG. 9A illustrates a case where the number of buttons the user can select at a time among the surface property setting buttons 911a to 911k is one. If one of the surface property setting buttons 911a to 911k is in the selected state when another surface property setting button is selected, the CPU 205 cancels the selection information about the surface property setting button selected first. The CPU 205 also brings the surface property setting button selected afterward into the selected state.

A cancel button 912 is a button for terminating the display of the paper attribute change screen 910. If the cancel button 912 is selected, the CPU 205 terminates the display of the paper attribute change screen 910 without changing the value of the paper attribute stored in the paper attribute value 903, and displays the paper information registration/editing screen 800 on the display unit included in the operation unit 204.

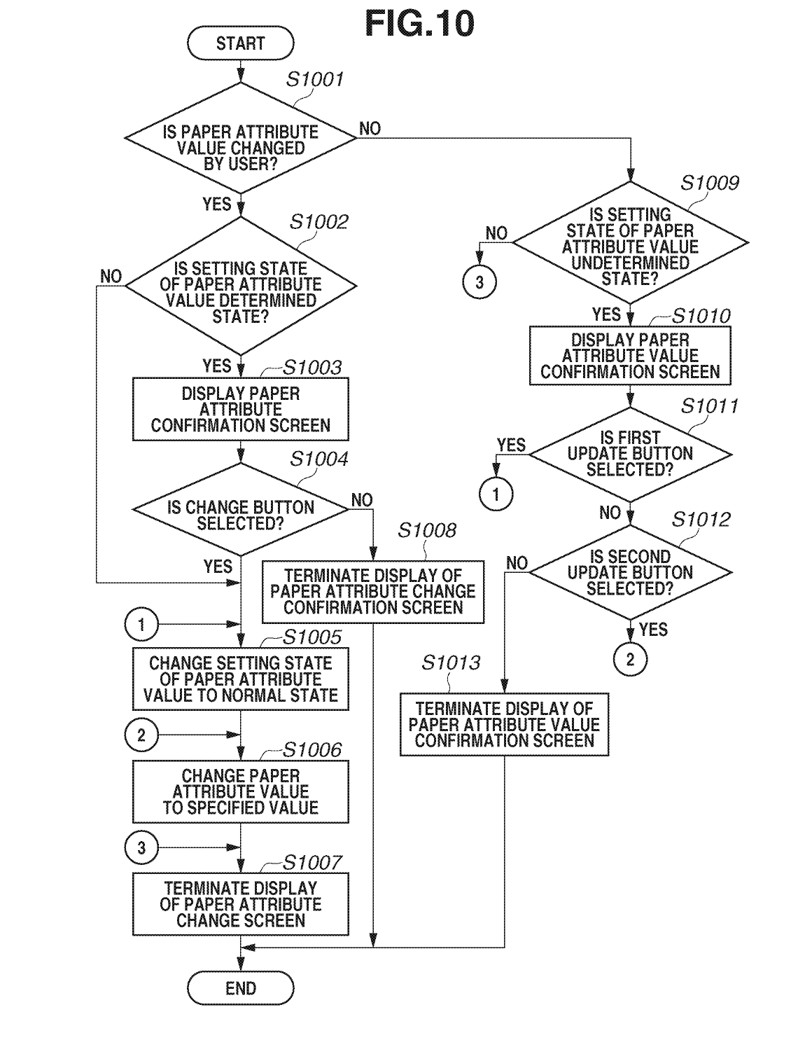

An OK button 913 is a button for making an operation to store the changed paper attribute value into the field of the paper attribute value 703. If the OK button 913 is selected, the processing of the flowchart of FIG. 10 to be described below is performed.

An allowable range of change may be set in advance for the content of at least one of sheet features (in the embodiment, paper attributes) whose content is identified based on the detection results of the media sensor 210. In such a case, the allowable range of change may be determined based on the detection accuracy (measurement accuracy) of the media sensor 210. For example, the detection accuracy of the media sensor 210 may be defined to be within the range of ±X% relative to the paper attribute value estimated from the detection results of the media sensor 210. In such a case, the paper attribute value may be changed within the range of greater than or equal to (the paper attribute value estimated from the detection results of the media sensor 210) × (1 - X/100) and less than or equal to (the paper attribute value estimated from the detection results of the media sensor 210) × (1 + X/100). An example of the paper attribute whose value is changed in such a manner is grammage. Alternatively, the allowable range of change may be defined based on the paper attribute value estimated from the detection results of the media sensor 210. For example, if the value estimated from the detection results of the media sensor 210 falls within one of first to nth ranges, the paper attribute value may be determined on the assumption that the paper attribute has a value (content) corresponding to that range. In such a case, if, for example, the value estimated from the detection results of the media sensor 210 falls near the boundary between two adjoining ranges, the paper attribute value may be changed to either of the values corresponding to the two ranges. An example of the paper attribute whose value is changed in such a manner is the surface property. For example, if the obtained value (content) of the surface property falls near the boundary between the range corresponding to coated paper and the range corresponding to uncoated paper, the value (content) of the surface property may be changed to either coated paper or uncoated paper. The allowable range of change set thus can be within an extent where there is no or little effect on the print product.

Return to the description of FIG. 8A. A cancel button 832 is a button for terminating the display of the paper information registration/editing screen 800. If the cancel button 832 is selected, the CPU 205 discards the paper information temporarily stored in the RAM 208 without reflecting the paper information on that stored in the HDD 209. The CPU 205 also ends the processing for registering new paper information or editing paper information. In such a case, the CPU 205 terminates the display of the paper information registration/editing screen 800, and displays the screen (for example, paper information management screen 600) displayed before the display of the paper information registration/editing screen 800 on the display unit included in the operation unit 204.

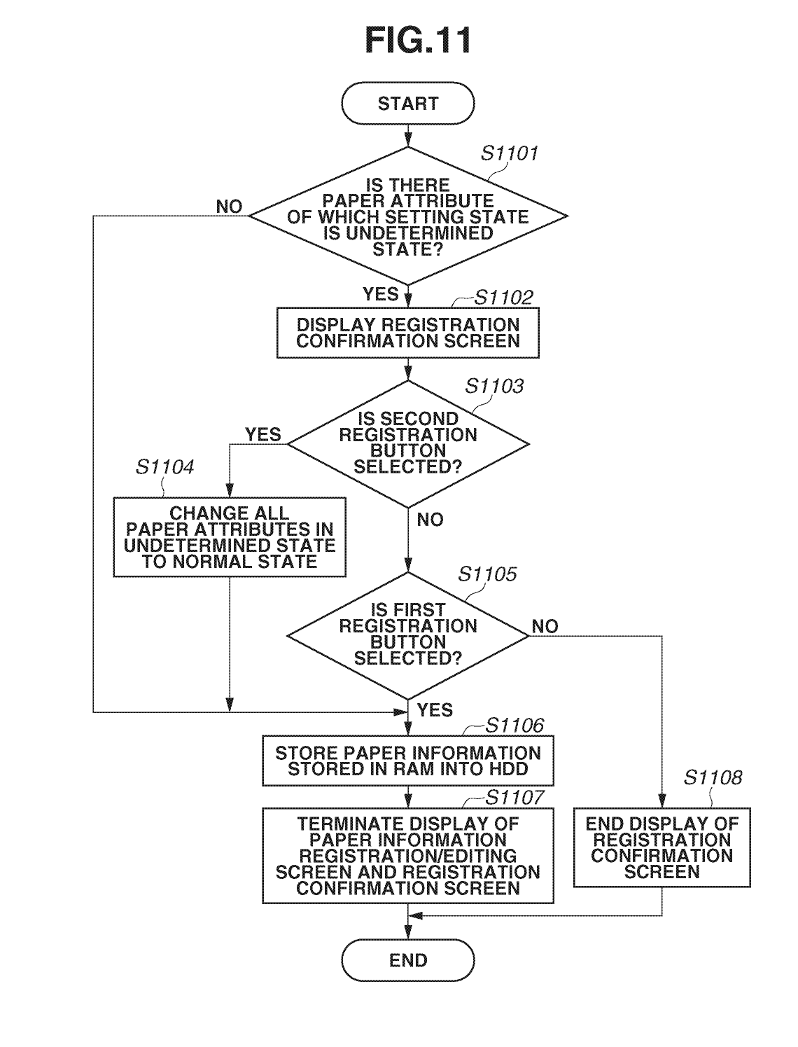

An OK button 833 is a button for performing operations to change paper information already registered in the MFP 101 or store new paper information. If the OK button 833 is selected, the processing of the flowchart of FIG. 11 to be described below is performed.

FIG. 10 is a flowchart for describing an example of the processing of the MFP 101 when an instruction to change a paper attribute value is issued. As described above, the embodiment deals with a case where the processing of the flowchart of FIG. 10 starts when the OK button 913 displayed on the paper attribute change screen 910 is selected.

In step S1001, the CPU 205 determines whether the paper attribute value is changed by the user. The embodiment deals with a case where the CPU 205 determines whether the paper attribute value included in the paper information 700 stored in the RAM 208 (value (content) stored in the field of the paper attribute value 703) and the value selected or input by the user are different. If, as a result of this determination, the paper attribute value is changed (the value (content) stored in the field of the paper attribute value 703 and the value selected or input by the user are different) (YES in step S1001), the processing proceeds to step S1002. On the other hand, if the paper attribute value is not changed (NO in step S1001), the processing proceeds to step S1008.

In step S1002, the CPU 205 determines whether the setting state of the paper attribute value instructed to be changed is the determined state. Whether the setting state is the determined state is determined based on whether the content (value) stored in the field of the paper attribute setting state 704 of the paper information 700 stored in the RAM 208 is the determined state.

If, as a result of this determination, the setting state of the paper attribute value instructed to be changed is the determined state (YES in step S1002), the processing proceeds to step S1003. On the other hand, if the setting state of the paper attribute value instructed to be changed is not the determined state (NO in step S1002), the processing skips steps S1003 and S1004 and proceeds to step S1005 to be described below.

In step S1003, the CPU 205 displays a paper attribute change confirmation screen on the display unit included in the operation unit 204. FIG. 9B is a diagram illustrating an example of a paper attribute change confirmation screen 920. When the processing of step S1003 is performed, the user is attempting to change the paper attribute value determined based on the detection values of the media sensor 210 (value estimated to be a correct value). The paper attribute change confirmation screen 920 is a screen for confirming with the user whether they are sure they want to change the paper attribute value. FIG. 9B illustrates a case where the paper attribute change confirmation screen 920 is displayed over the paper attribute change screen 910 as a subordinate screen of the paper attribute change screen 910. Note that when the display of the paper attribute change screen 910 is terminated, the display of the paper attribute change confirmation screen 920 is terminated as well. The embodiment deals with a case where the paper attribute change confirmation screen 920 is displayed to provide a display for prompting confirmation of whether sheet features are to be registered or edited.

In FIG. 9B, a change button 921 is a button for selecting to change the paper attribute value stored in the field of the paper attribute value 703 using the paper attribute value selected or input by the user.

A cancel button 922 is a button for terminating the display of the paper attribute change confirmation screen 920.

Return to the description of FIG. 10. With the paper attribute change confirmation screen 920 displayed in step S1003, the processing proceeds to step S1004.

In step S1004, the CPU 205 determines whether the change button 921 is selected on the paper attribute change confirmation screen 920. If the change button 921 is selected (YES in step S1004), the processing proceeds to step S1005. If the change button 921 is not selected and the cancel button 922 is selected (NO in step S1004), the processing proceeds to step S1008 to be described below.

In step S1005, the CPU 205 changes the value (content) in the field of the paper attribute setting state 704 corresponding to the paper attribute whose value is changed to the normal state.

In step S1006, the CPU 205 changes the value (content) in the field of the paper attribute value 703 to the value (content) specified on the paper attribute change screen 910.

In step S1007, the CPU 205 terminates the display of the paper attribute change screen 910, and displays the paper information registration/editing screen 900 on the display unit included in the operation unit 204. Once the processing of step S1007 ends, the processing of the flowchart of FIG. 10 ends.

As described above, if, in step S1004, the cancel button 922 of the paper attribute change confirmation screen 920 is selected (NO in step S1004), the processing proceeds to step S1008.

In step S1008, the CPU 205 terminates the display of the paper attribute change confirmation screen 920. In such a case, the display of the display unit included in the operation unit 204 is switched to the paper attribute change screen 910. Here, the value (content) of the paper attribute stored in the field of the paper attribute value 703 of the paper information 700 stored in the RAM 208 is not changed. Once the processing of step S1008 ends, the processing of the flowchart of FIG. 10 ends.

As described above, if, in step S1001, the paper attribute value is not changed (the value stored in the field of the paper attribute value 703 does not differ from the value selected or input by the user) (NO in step S1001), the processing proceeds to step S1009.

In step S1009, the CPU 205 determines whether the setting state of the paper attribute value instructed to be changed is the undetermined state. Whether the setting state is the undetermined state is determined based on whether the content (value) stored in the field of the paper attribute setting state 704 of the paper information 700 stored in the RAM 208 is the undetermined state. If, as a result of this determination, the setting state of the paper attribute value instructed to be changed is not the undetermined state (NO in step S1009), the processing proceeds to the foregoing step S1007.

On the other hand, if the setting state of the paper attribute value instructed to be changed is the undetermined state (YES in step S1009), the processing proceeds to step S1010.

In step S1010, the CPU 205 displays a paper attribute value confirmation screen on the display unit included in the operation unit 204. FIG. 9C is a diagram illustrating an example of a paper attribute value confirmation screen 930. When the processing of step S1010 is performed, the user is attempting to update the paper attribute value that is not successfully determined based on the detection values of the media sensor 210, without changing the paper attribute value. The paper attribute value confirmation screen 930 is a screen for confirming with the user whether to update the paper attribute value that is not successfully determined based on the detection values of the media sensor 210. FIG. 9C illustrates a case where the paper attribute value confirmation screen 930 is displayed over the paper attribute change screen 910 as a subordinate screen of the paper attribute change screen 910. When the display of the paper attribute change screen 910 is terminated, the display of the paper attribute value confirmation screen 930 is terminated as well.

In FIG. 9C, a confirmed update button (first update button) 931 is a button for selecting confirmation that the paper attribute value is correct.

A second update button 932 is a button for selecting absence of confirmation that the paper attribute value is correct.

A cancel button 933 is a button for terminating the display of the paper attribute value confirmation screen 930.

Return to the description of FIG. 10. With the paper attribute value confirmation screen 930 displayed in step S1010, the processing proceeds to step S1011.

In step S1011, the CPU 205 determines whether the first update button 931 (update as confirmed) is selected. If, as a result of this determination, the first update button 931 is selected (YES in step S1011), the processing proceeds to the foregoing step S1005. As described above, in step S1005, the CPU 205 changes to the normal state the value (content) in the field of the paper attribute setting state 704 corresponding to the paper attribute whose value (content) is changed.

On the other hand, if the first update button 931 is not selected (NO in step S1011), the processing proceeds to step S1012.

In step S1012, the CPU 205 determines whether the second update button 932 (update anyway) is selected. If, as a result of this determination, the second update button 932 is selected (YES in step S1012), the processing proceeds to the foregoing step S1006. As described above, in step S1006, the CPU 205 changes the value (content) in the field of the paper attribute value 703 to the value (content) specified on the paper attribute change screen 910. Here, the value (content) in the field of the paper attribute setting state 704 corresponding to the paper attribute whose value (content) is changed is not changed to the normal state.

On the other hand, if the second update button 932 (update anyway) is not selected and a cancel button 973 is selected (NO in step S1012), the processing proceeds to step S1013. In step S1013, the CPU 205 terminates the display of the paper attribute value confirmation screen 930. Here, the display of the display unit included in the operation unit 204 is switched to the paper attribute change screen 910. Moreover, in such a case, the value (content) of the paper attribute stored in the field of the paper attribute value 703 of the paper information 700 stored in the RAM 208 is not changed. Once the processing of step S1013 ends, the processing of the flowchart of FIG. 10 ends.

FIG. 11 is a flowchart for describing an example of processing of the MFP 101 when an instruction to change paper information already registered in the MFP 101 or register new paper information is issued. As described above, the embodiment deals with a case where the processing of the flowchart of FIG. 11 starts when the OK button 833 displayed on the paper information registration/editing screen 800 is selected.

In step S1101, the CPU 205 determines whether the paper attributes constituting the paper information include any paper attribute of which the setting state is the undetermined state. Whether there is a paper attribute of which the setting state is the undetermined state is determined based on whether the values (content) stored in the fields of the paper attribute setting state 704 of the paper information 700 stored in the RAM 208 include the undetermined state. If, as a result of this determination, the paper attributes constituting the paper information do not include any paper attribute of which the setting state is the undetermined state (NO in step S1101), the processing skips steps S1102 to S1105 and proceeds to step S1106 to be described below.

On the other hand, if the paper attributes constituting the paper information include any paper attribute of which the setting value is the undetermined state (YES in step S1101), the processing proceeds to step S1102.

In step S1102, the CPU 205 displays a registration confirmation screen on the display unit included in the operation unit 204. FIG. 8C is a diagram illustrating an example of a registration confirmation screen 840. When the processing of step S1102 is performed, the paper attributes that the user is attempting to register anew or update include a paper attribute or attributes whose values are not successfully determined based on the detection values of the media sensor 210 (paper attributes to which complemented values are still set). The content (values) in the fields of the paper attribute setting state 704 corresponding to such paper attributes is the undetermined state. The registration confirmation screen 840 is a screen for confirming with the user whether they are sure they want to store (change or register anew) the paper attributes. The embodiment deals with a case where the registration confirmation screen 840 is displayed to provide a display for prompting confirmation of whether sheet features are to be registered or edited.

In FIG. 8C, a first registration button 841 is a button for selecting to store (register anew or change) the paper information without confirming the paper attribute values of which the setting state is the undetermined state.

A second registration button 842 is a button for confirming that the paper attribute values of which the setting state is the undetermined state are correct values matching the actual paper, and selecting to store the paper information.

A cancel button 843 is a button for terminating the display of the registration confirmation screen 840.

Return to the description of FIG. 11. With the registration confirmation screen 840 displayed in step S1102, the processing proceeds to step S1103.

In step S1103, the CPU 205 determines whether the second registration button 842 (register as confirmed) is selected. If, as a result of this determination, the second registration button 842 is selected (YES in step S1103), the processing proceeds to step S1104.

In step S1104, the CPU 205 changes to the normal state the values of the paper attribute setting state 704 corresponding to the paper attributes where the undetermined state is stored as the values (content) of the paper attribute setting state 704 among the paper attributes included in the paper information 700 stored in the RAM 208. The result is that the setting states of the values of such paper attributes are no longer the underdetermined state. The paper information registration/editing screen 800, when next displayed, therefore does not display those paper attributes as being ones that are to be changed. Once the processing of step S1104 ends, the processing proceeds to step S1106 to be described below.

If, as a result of the determination in step S1103, the second registration button 842 is not selected (NO in step S1103), the processing proceeds to step S1105.

In step S1105, the CPU 205 determines whether the first registration button 841 (register anyway) is selected. In the case where the first registration button 841 is selected, correct values may not be set for paper attributes where the undetermined state is set as the setting states of the paper attribute values stored in the paper attribute setting state 704. When the first registration button 841 is selected, such values are stored with their setting states still being the undetermined state. The paper information registration/editing screen 800, when next displayed, thus enables the user to recognize that correct values may not be set for those paper attributes, from the display of the fields of the paper attribute setting state 822.

If, as a result of the determination in step S1105, the first registration button 841 is not selected and the cancel button 843 is selected (NO in step S1105), the processing proceeds to step S1108 to be described below. On the other hand, if the first registration button 841 is selected (YES in step S1105), the processing proceeds to step S1106.

In step S1106, the CPU 205 stores the sheet information stored in the RAM 208 into the HDD 209. If the sheet information is not stored in the HDD 209 yet, the CPU 205 stores the sheet information stored in the RAM 208 into the HDD 209 as new sheet information. On the other hand, if the sheet information is already stored in the HDD 209, the CPU 205 overwrites the paper information stored in the HDD 209 with the paper information stored in the RAM 208. Once the paper information stored in the RAM 208 is stored into the HDD 209, the CPU 205 may delete the paper information stored in the RAM 208.

In step S1107, the CPU 205 terminates the display of the paper information registration/editing screen 800 and the registration confirmation screen 840. Here, the screen displayed before the display of the paper information registration/editing screen 800 is displayed on the display unit included in the operation unit 204. Once the processing of step S1107 ends, the processing of the flowchart of FIG. 11 ends.

As described above, if, as a result of the determination in step S1105, the first registration button 841 (register anyway) is not selected and the cancel button 843 is selected (NO in step S1105), the processing proceeds to step S1108.

In step S1108, the CPU 205 terminates the display of the registration confirmation screen 940. In such a case, the paper information registration/editing screen 800 is displayed on the display unit of the operation unit 204. Once the processing of step S1108 ends, the processing of the flowchart of FIG. 11 ends.

Once the processing of the flowchart of FIG. 11 ends, the CPU 205 displays on the display unit of the operation unit 204 the paper information registration/editing screen 800 including the content displayed before the start of the processing illustrated in the flowchart of FIG. 11.

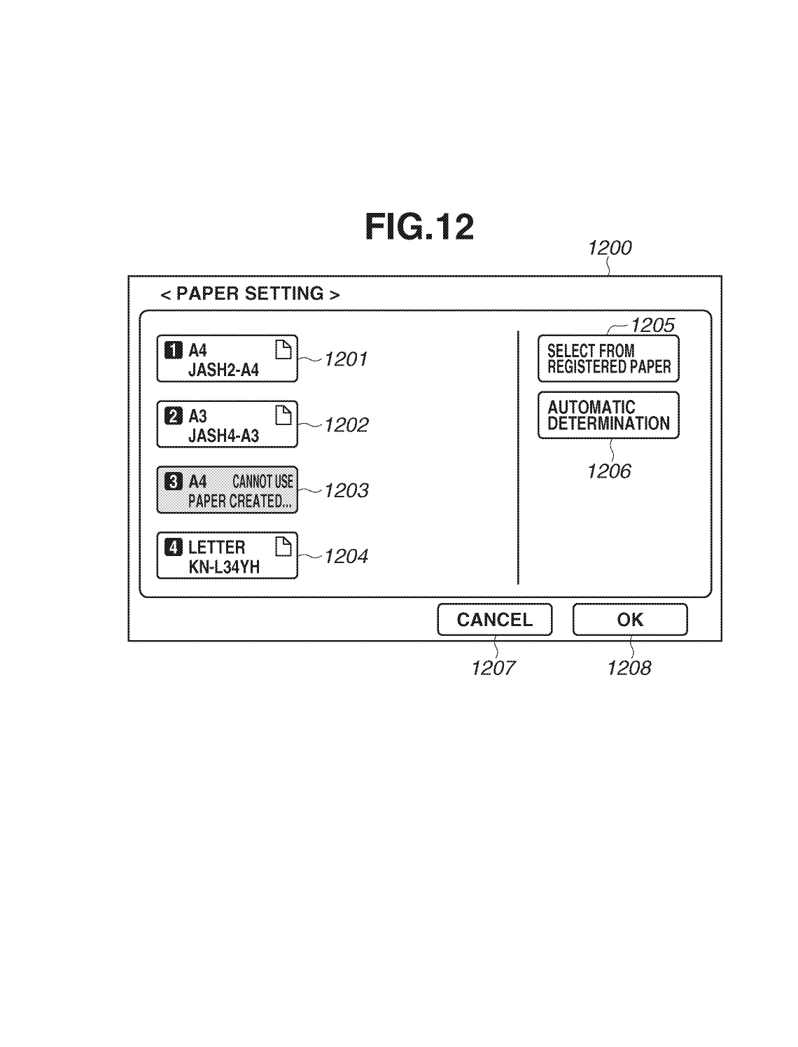

FIG. 12 is a diagram illustrating an example of a paper feed unit setting screen 1200. The paper feed unit setting screen 1200 is a screen for setting paper information 700 for the paper feed units 231 to 234. FIG. 12 illustrates the paper feed unit setting screen 1200 after the detection paper selection button 623 is selected on the detection paper selection screen 620, paper attributes determined based on the detection results of the media sensor 210 are registered, and the first registration button 841 is selected to store the paper information 700. The paper feed unit setting screen 1200 is displayed on the display unit included in the operation unit 204, for example. The paper information 700 set for the paper feed units 231 to 234 is stored in the RAM 208.

Paper feed unit selection buttons 1201 to 1204 are buttons for selecting a paper feed unit to set paper information for. The paper feed unit selection buttons 1201, 1202, 1203, and 1204 correspond to the paper feed units 231, 232, 233, and 234, respectively. FIG. 12 illustrates a case where the number of buttons the user can select at a time among the paper feed unit selection buttons 1201 to 1204 is one. The button selected by the user among the paper feed unit selection buttons 1201 to 1204 enters a selected state. If one of the paper feed unit selection buttons 1201 to 1204 is in the selected state when another paper feed unit selection button is selected, the CPU 205 cancels the selection information about the paper feed unit selection button selected first. The CPU 205 also brings the paper feed unit selection button selected afterward into the selected state.

FIG. 12 illustrates a case where "cannot use" is displayed on the paper feed unit selection button 1203 corresponding to the same paper feed unit 233 as that corresponding to the detection paper selection button 623 in the selected state on the detection paper selection screen 620 illustrated in FIG. 6B. The reason for the display is that the generated paper information 700 includes paper attributes of which the setting states stored in the fields of the paper attribute setting state 704 are the undetermined state. The CPU 205 exercises control so that the paper in the third paper feed unit 233 is not usable for printing during print processing. To use the paper in the third paper feed unit 233 for printing, the setting states of the paper attribute values stored in the fields of the paper attribute setting state 704 to be changed from the undetermined state to the normal state. An example of the operation and processing for changing the setting state of a paper attribute value stored in the field of the paper attribute setting state 704 into the normal state has been described with reference to FIGS. 8A to 11. As described above, in the embodiment, control is exercised so that the paper in the paper feed unit 233 is unable to be used for printing during print processing. The embodiment deals with a case where second prohibition processing is performed to prohibit printing of sheets for which no sheet information including at least either sheet features identified by a predetermined identification method or sheet features whose content is confirmed by the user is set.

A selection button 1205 is a button for setting paper information registered in the MFP 101 for paper feed units. If the selection button 1205 is selected, the CPU 205 displays a not-illustrated registered paper selection screen on the display unit included in the operation unit 204. This registered paper selection screen displays information including a list of paper information registered in the MFP 101. Here, the CPU 205 may disable selection of or hide paper information 700 that includes any paper attribute where the setting state of the paper attribute value stored in the field of the paper attribute setting state 704 is the undetermined state. This prevents the paper identified by such paper information from being set for paper feed units. The CPU 205 stores paper information selected by the user from the list of paper information into the RAM 208 as paper information to be set for the paper feed unit corresponding to the paper feed unit selection button in the selected state among the paper feed unit selection buttons 1201 to 1204.

An automatic determination button 1206 is a button for assigning paper information to the paper feed unit using the media sensor 210. If the automatic determination button 1206 is selected, the CPU 205 stores into the RAM 208 the selection to automatically determine (at least part of) paper information to be set for the paper feed unit corresponding to the paper feed unit selection button in the selected state, based on the detection values of the media sensor 210.

FIG. 12 illustrates a case where the selection button 1205 and the automatic determination button 1206 are selectable when one of the paper feed unit selection buttons 1201 to 1204 is in the selected state.

A cancel button 1207 is a button for terminating the display of the paper feed unit setting screen 1200. If the cancel button 1207 is selected, the CPU 205 terminates the display of the paper feed unit setting screen 1200, and displays, on the display unit included in the operation unit 204, a not-illustrated screen displayed before the display of the paper feed unit setting screen 1200.

An OK button 1208 is a button for terminating the paper feed unit setting screen 1200. If the OK button 1208 is selected, the CPU 205 stores into the HDD 209 the information that is stored in the RAM 208 based on the operations on the paper feed unit setting screen 1200.

The first embodiment has been described above. As described in Japanese Patent Laid-Open No. 2010-217742, paper attributes can be generated from the detection results of the media sensor 210, for example. However, as described above, paper attributes for managing paper may include ones that are unable to be generated from the detection results of the media sensor 210. The reason is that paper features include features that are not associated or slightly associated with sheet features obtained based on the detection results of the media sensor 210.

In such a case, for example, paper information may be generated by complementing the paper attributes unable to be generated from the detection results of the media sensor 210 with default values. With this approach, however, before applying the paper information including the paper attributes complemented with the default values to a print job, the user is to change the complemented default values of the paper attributes to match the actual paper. The paper attributes generated from the detection results of the media sensor 210 depend, for example, on the performance of the media sensor 210 and the calculation algorithm of the paper attributes. It is therefore not easy for the user to determine paper attributes whose values are to be changed. Moreover, the user may forget to change paper attribute values into correct values, or may change the correct values of paper attributes generated based on the detection results of the media sensor 210 into erroneous values.

For example, if the calculation algorithm of the paper attributes uses machine learning or if paper attributes are inferred from already registered paper information, paper attributes that can be generated may vary depending on the training status or the registration status. This makes it more difficult for the user to figure out the paper attributes whose values are to be changed.

As described above, it is not easy for the user to distinguish paper attributes that are generated based on the detection results of the media sensor 210 and paper attributes that are unable to be generated based on the detection results of the media sensor 210 and are to be set by the user. This deteriorates user convenience.

In view of this, in the embodiment, the MFP 101 displays paper attributes that are not associated or slightly associated with paper features obtained based on the detection results of the media sensor 210 and whose values are therefore unable to be determined, in a manner distinguishable from the other paper attributes. For example, the MFP 101 displays paper attributes complemented with default values and paper attributes based on the detection results of the media sensor 210 in a mutually distinguishable manner on the paper information editing screen. This can improve user convenience when figuring out the features of paper to be used for printing based on the detection results of the media sensor 210. For example, the user can thereby clearly identify paper attributes whose values are to be changed. The user can thus appropriately change the paper attribute values. The user can also register correct paper information. This enables the user to manage paper appropriately. Moreover, in the embodiment, the MFP 101 issues a warning if the user attempts to complete the registration of paper information without setting paper attribute values that are default values. This can prevent omission of paper information settings. Furthermore, in the embodiment, if the user attempts to change paper attribute values that are determined based on the detection results of the media sensor 210, the MFP 101 confirms with the user whether to proceed with the change. This can prevent paper attribute values from being changed to erroneous values.

In the embodiment, if paper attribute values that are unable to be determined based on the detection results of the media sensor 210 are not changed by the user or confirmed by the user, the MFP 101 disables the use of the paper with those paper attributes for printing. This can prevent printing on paper with incorrect paper information. With the configuration described above, erroneous registration of paper information using the media sensor 210 is prevented and appropriate paper management is implemented.

### Second Embodiment

Next, a second embodiment will be described. The first embodiment has dealt with the case where the fields of the paper attribute setting state 822 are provided on the paper information registration/editing screen 800, whereby paper attributes whose values are to be set by the user are displayed as distinguished from the other paper attributes. The paper attributes whose values are to be set by the user refer to ones whose values are not successfully determined based on the detection values of the media sensor 210. Here, paper attributes whose values are successfully determined based on the detection values of the media sensor 210 and those not (paper attributes whose values are to be set by the user) are displayed in a mixed manner. This can increase the user's burden in searching for paper attributes whose values are to be set by the user, for example, when there are many types of paper attributes.

In the embodiment, paper attributes whose values are to be set by the user and the other paper attributes are therefore displayed separately so that the paper attributes whose values are to be set by the user can be checked more easily. This reduces the user's effort to search for paper attributes that are to be set, and prevents the user from forgetting to change the paper attribute values. The embodiment and the first embodiment thus differ in part of the method for displaying the information about the paper attributes. In the description of the embodiment, portions similar to the first embodiment are therefore denoted by the same reference numerals as those used in FIGS. 1 to 12, and a detailed description will be omitted.

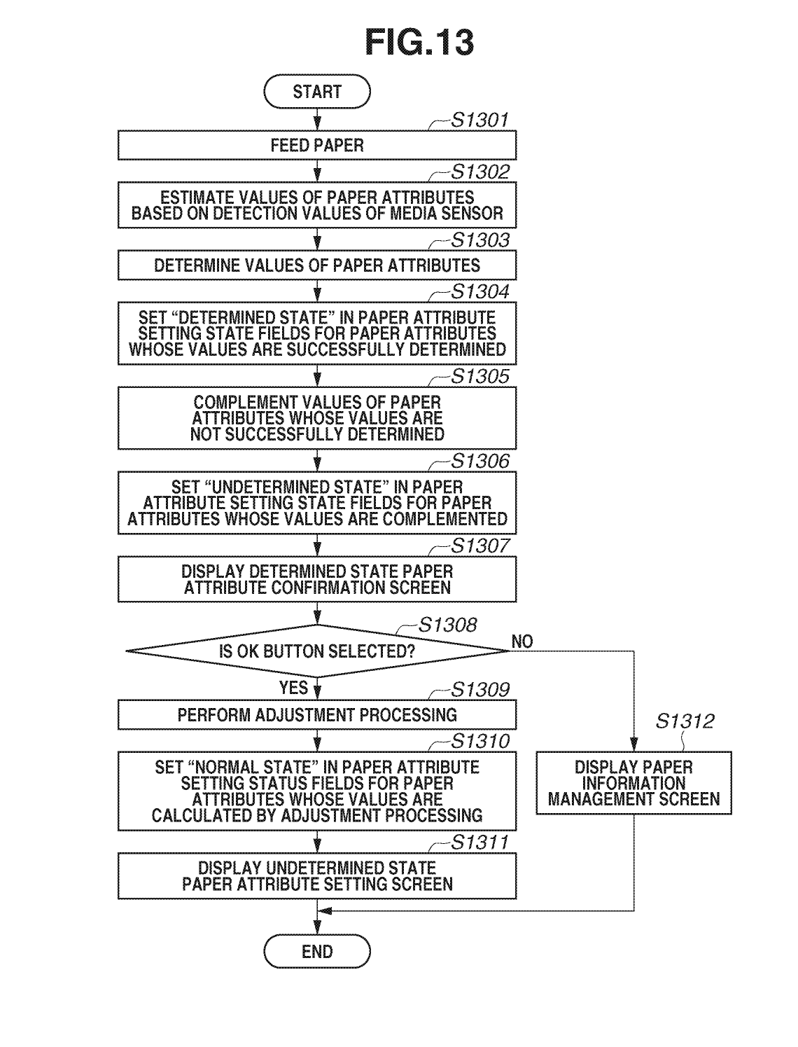

FIG. 13 is a flowchart for describing an example of processing of the MFP 101 when an instruction to register paper information using the media sensor 210 is issued. In the first embodiment, the flowchart corresponding to the flowchart illustrated in FIG. 13 is that illustrated in FIG. 5.

The processing of steps S1301 to S1306 is similar to that of steps S501 to S506.

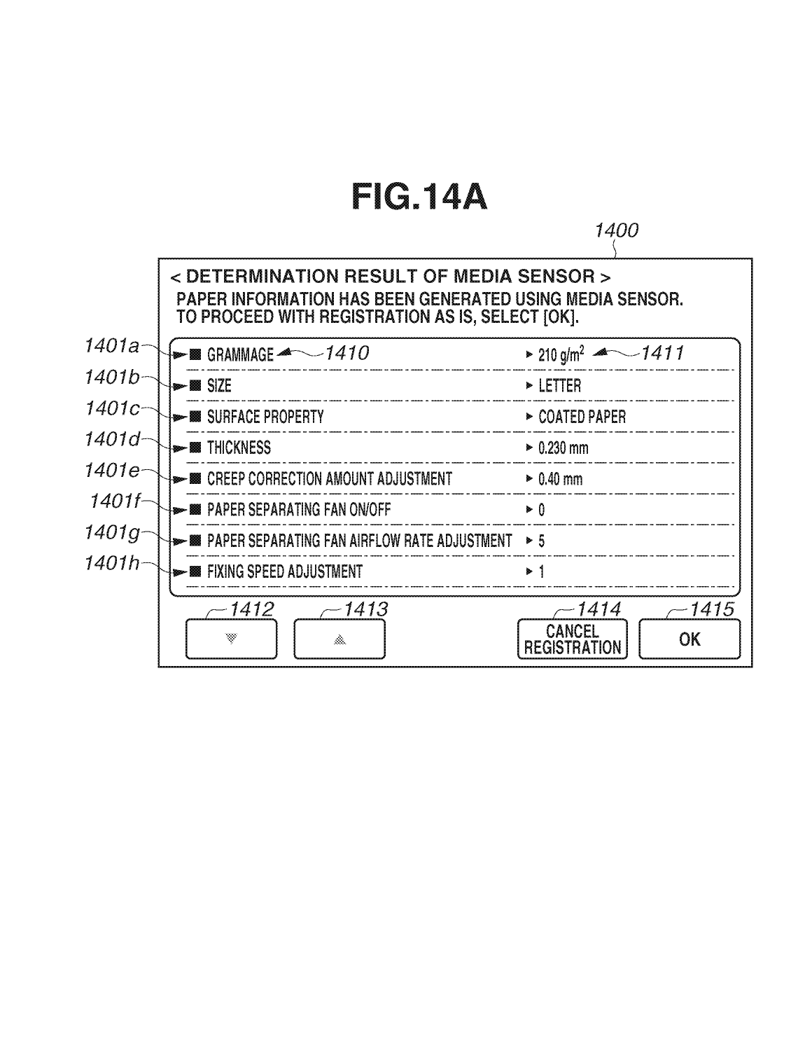

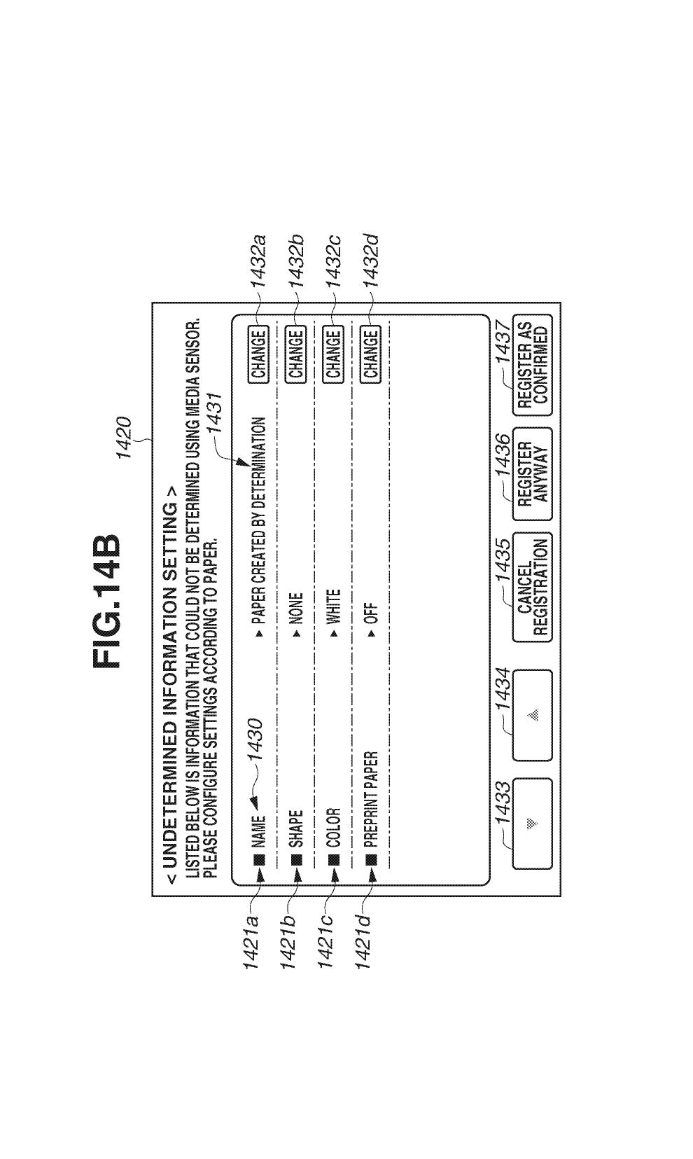

In step S1307, the CPU 205 displays a determined state paper attribute confirmation screen on the display unit included in the operation unit 204. FIG. 14A is a diagram illustrating an example of a determined state paper attribute confirmation screen 1400. The determined state paper attribute confirmation screen 1400 is a screen for confirming the values of the paper attributes for which the determined state is set in the fields of the paper attribute setting state 704 by the processing of step S1304. The paper attributes for which the determined state is set in the fields of the paper attribute setting state 704 by the processing of step S1304 are ones whose values are successfully determined based on the detection values of the media sensor 210 in step S1303.

FIG. 14A illustrates a case where, like the paper information registration/editing screen 800, the determined state paper attribute confirmation screen 1400 includes the fields of paper attribute items 1401a to 1401h, which display the fields of a paper attribute name 1410 and the fields of a paper attribute value 1411. However, in one embodiment, the paper attributes displayed in the fields of the paper attribute items 1401a to 1401h are only those whose values are successfully determined based on the detection values of the media sensor 210 (i.e., paper attributes for which the determined state is stored in the fields of the paper attribute setting state 704). The values of the paper attributes (values stored in the fields of the paper attribute value 703) for which the value (content) indicating the determined state is stored in the fields of the paper attribute setting state 704 are paper attribute values determined based on the detection values of the media sensor 210 (values estimated to be correct values). The determined state paper attribute confirmation screen 1400 illustrated in FIG. 14A therefore displays no paper attribute change buttons corresponding to the paper attribute change buttons 823a to 823n illustrated in FIGS. 8A and 8B. This can prevent the user from accidentally changing the values that are stored in the fields of the paper attribute value 703 as paper attribute values determined based on the detection values of the media sensor 210 (values estimated to be correct values). The embodiment deals with a case where the values of the paper attributes for which the determined state is stored in the fields of the paper attribute setting state 704 can be changed on the paper information registration/editing screen 800 displayed after registration of the paper information. However, the values of the paper attributes (values stored in the fields of the paper attribute value 703) for which the determined state is stored in the fields of the paper attribute setting state 704 may be made unchangeable. The embodiment deals with a case where first prohibition processing for prohibiting the editing of sheet features identified by a predetermined identification method is implemented by displaying no sheet attribute change buttons on the determined state paper attribute confirmation screen 1400.

Page switch buttons 1412 and 1413 are buttons for switching paper attribute items to be displayed. If there are no paper attribute items to be switched and displayed using the page switch buttons 1412 and 1413, the page switch buttons 1412 and 1413 become unselectable.

A registration cancel button 1414 is a button for cancelling the registration of paper information using the media sensor 210.

An OK button 1415 is a button for terminating the display of the determined state paper attribute confirmation screen 1400.

Return to the description of FIG. 13. In step S1307, the CPU 205 waits until the registration cancel button 1414 or the OK button 1415 is selected on the determined state paper attribute confirmation screen 1400. When the registration cancel button 1414 or the OK button 1415 is selected, the processing proceeds to step S1308.

In step S1308, the CPU 205 determines whether the OK button 1415 is selected. If, as a result of this determination, the OK button 1415 is not selected and the registration cancel button 1414 is selected (NO in step S1308), the processing proceeds to step S1312 to be described below.

On the other hand, if the OK button 1415 is selected (YES in step S1308), the CPU 205 terminates the display of the determined state paper attribute confirmation screen 1400. The processing then proceeds to step S1309. The processing of steps S1309 and S1310 is similar to that of steps S507 and S508 in FIG. 5.

In step S1310, the CPU 205 sets the normal state in the fields of the paper attribute setting state 704 corresponding to paper attributes whose values are calculated by performing the adjustment processing in step S1309. The processing proceeds to step S1311.

In step S1311, the CPU 205 displays an undetermined state paper attribute setting screen 1420 illustrated in FIG. 14B on the display unit included in the operation unit 204. The undetermined state paper attribute setting screen 1420 is a screen for setting the values of the paper attributes for which the undetermined state is set in the fields of the paper attribute setting state 704 by the processing of step S1306. The paper attributes for which the undetermined state is set in the fields of the paper attribute setting state 704 are ones whose values are not successfully determined based on the detection values of the media sensor 210. Once the processing of step S1311 ends, the processing of the flowchart of FIG. 13 ends.

As described above, if, as a result of the determination in step S1308, the registration cancel button 1414 is selected (NO in step S1308), the processing proceeds to step S1312. In step S1312, the CPU 205 cancels the registration of the paper information. In such a case, the CPU 205 terminates the display of the determined state paper attribute confirmation screen 1400, and displays the paper information management screen 600 on the display unit included in the operation unit 204. Here, the CPU 205 may discard the data related to the paper information stored in the RAM 208. Once the processing of step S1312 ends, the processing of the flowchart of FIG. 13 ends.

The user then makes operations for setting values to the paper attributes where the setting state is the undetermined state. An example of the processing of the CPU 205 related to the user operations is similar to the processing of the flowchart illustrated in FIG. 10. A detailed description of the operations and processing will thus be omitted.

The undetermined state paper attribute setting screen 1420 illustrated in FIG. 14B will now be described.

FIG. 14B illustrates a case where the undetermined state paper attribute setting screen 1420 includes the fields of paper attribute items 1421a to 1421d, which display the fields of a paper attribute name 1430, the fields of a paper attribute value 1431, and paper attribute change buttons 1432a to 1432d. Such configuration is similar to that of the paper information registration/editing screen 800. However, in one embodiment, the paper attributes displayed in the fields of the paper attribute items 1421a to 1421d are only those whose values are not successfully determined based on the detection values of media sensor 210 (paper attributes for which the undetermined state is stored in the fields of the paper attribute setting state 704). The values of the paper attributes for which the value (content) stored in the fields of the paper attribute setting state 704 is the undetermined state are to be input or selected by the user themselves. In one embodiment, since the undetermined state paper attribute setting screen 1420 displays only the paper attributes of which the value setting state is the undetermined state, the user's burden in searching for paper attributes whose values are to be set can be reduced.

Page switch buttons 1433 and 1434 are buttons for switching paper attribute items to be displayed. If there are no paper attribute items to be switched and displayed using the page switch buttons 1433 and 1434, the page switch buttons 1433 and 1434 become unselectable.

The paper attribute change buttons 1432a to 1432d are buttons for changing the paper attribute values displayed in the fields of the paper attribute items 1421a to 1421d (values stored in the fields of the paper attribute value 703). If one of the paper attribute change buttons 1432a to 1432d is selected, the paper attribute change screen 910 for changing the value of the paper attribute corresponding to the selected button is displayed. An example of the processing here is similar to the processing of the flowchart of FIG. 10. A description of this processing example will thus be omitted here.

A registration cancel button 1435 is a button for cancelling the registration of paper information using the media sensor 210.

A first registration button 1436 is a button for selecting to store (register anew or change) the paper information without confirming the paper attribute values of which the setting state is the undetermined state.

A second registration button 1437 is a button for confirming that the paper attribute values of which the setting state is the undetermined state are correct values matching the actual paper, and selecting to store the paper information.

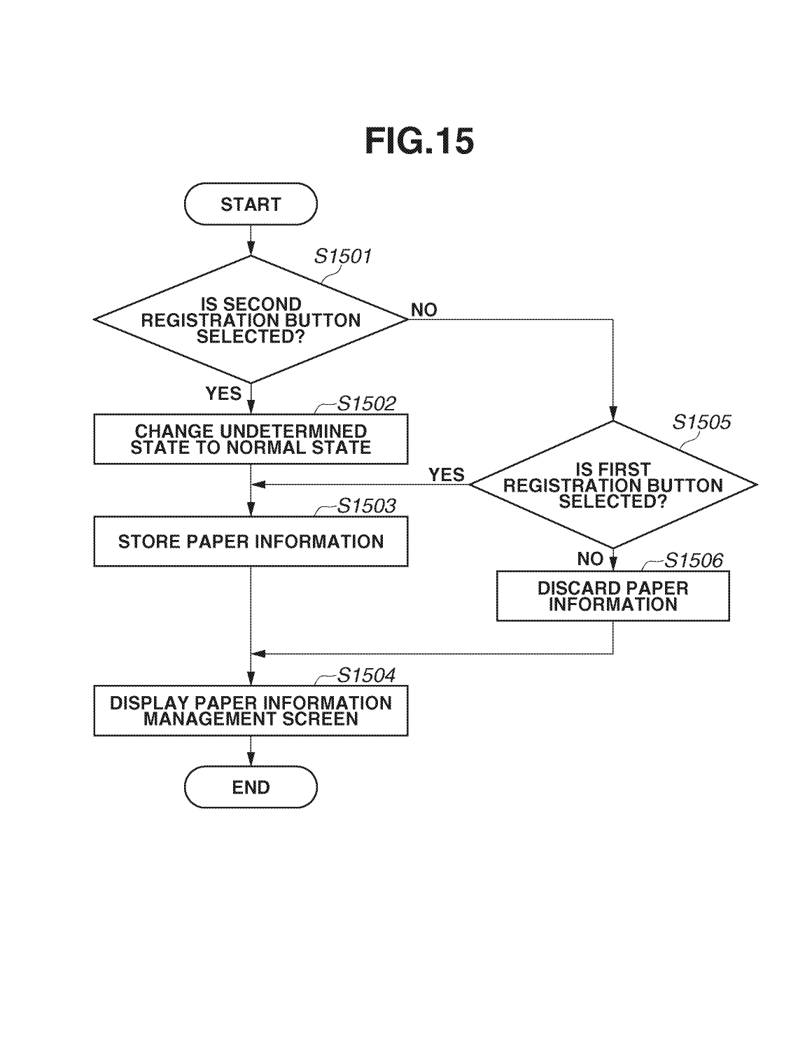

FIG. 15 is a flowchart for describing an example of processing of the MFP 101 when an operation to terminate the undetermined state paper attribute setting screen 1420 is accepted. The operation to terminate the undetermined state paper attribute setting screen 1420 refers to a selection operation on one of the first registration button 1436, second registration button 1437, and registration cancel button 1435.

In step S1501, the CPU 205 determines whether the second registration button 1437 (register as confirmed) is selected. If, as a result of this determination, the second registration button 1437 is not selected (NO in step S1501), the processing proceeds to step S1505. On the other hand, if the second registration button 1437 is selected (YES in step S1501), the processing proceeds to step S1502.

In step S1502, the CPU 205 changes the undetermined state stored in the fields of the paper attribute setting state 704 of the paper information 700 stored in the RAM 208 to the normal state.

In step S1503, the CPU 205 stores the paper information 700 stored in the RAM 208 into the HDD 209 as new paper information 700.

In step S1504, the CPU 205 terminates the display of the undetermined state paper attribute setting screen 1420, and displays the paper information registration/editing screen 800 on the display unit included in the operation unit 204. The editing of the paper information 700 after the registration of the paper information 700 is implemented, for example, by performing the processing of the flowcharts described with reference to FIGS. 10 and 11 in conjunction with the screens illustrated in FIGS. 8A to 9C.

As described above, if, in step S1501, the second registration button 1437 (register as confirmed) is determined to not be selected (NO in step S1501), the processing proceeds to step S1505.

In step S1505, the CPU 205 determines whether the first registration button 1436 (register anyway) is selected. If, as a result of this determination, the first registration button 1436 is selected (YES in step S1505), the processing proceeds to the foregoing step S1503. In such a case, the paper information 700 that still includes paper attributes where the setting state is the undetermined state may be stored into the HDD 209. If there is a paper attribute where the setting state is the undetermined state, like the first embodiment, the user can identify from the display of the field of the paper attribute setting state 822 that the paper attribute is one for which a correct value may not be set.

On the other hand, if the first registration button 1436 (register anyway) is not selected and the registration cancel button 1435 is selected (NO in step S1505), the processing proceeds to step S1506. In step S1506, the CPU 205 discards the paper information 700 stored in the RAM 208. Once the processing of step S1506 ends, the processing proceeds to the foregoing step S1504.

In the embodiment, the paper feed unit setting screen 1200 illustrated in FIG. 12 is a display example in the case where the first registration button 1436 is selected instead of the first registration button 841. In the embodiment, the processing for changing the paper attribute setting state 704 to the normal state is performed, for example, by using the undetermined state paper attribute setting screen 1420 and the like.

The second embodiment has been described above. In the embodiment, the MFP 101 displays only paper attributes whose values are to be set by the user (paper attributes whose values are not successfully determined based on the detection results of the media sensor 210) among the sheet attributes included in the paper information 700. This can reduce the user's burden in searching for paper attributes whose values are to be set by the user themselves. In the embodiment, the MFP 101 also displays information about paper attributes whose values are determined based on the determination results of the media sensor 210 so that the user is unable to change the values of those paper attributes. This can reduce the possibility of the user accidentally changing the paper attribute values that are determined based on the detection results of the media sensor 210.

According to an embodiment of the disclosure, user convenience in identifying the features of sheets to be used for printing based on sensor detection results can be improved.

### Other Embodiments

Embodiment(s) of the disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-002415, filed January 7, 2025, which is hereby incorporated by reference herein in its entirety.

What is claimed is:

1. An apparatus comprising:
at least one memory storing instructions; and
at least one processor that, upon execution of the stored instructions, configures the at least one processor to operate as:
an identification unit configured to identify a feature of a sheet to be used for printing, and
a display control unit configured to display sheet information including the feature of the sheet on a display device,
wherein the display control unit is configured to display the sheet information including features of the sheet identified by the identification unit using respective different identification methods on the display device in a mutually distinguished manner, and
wherein the identification methods for the features of the sheet by the identification unit include an identification method based on a detection result of a detection unit configured to detect a physical quantity corresponding to a feature of the sheet during conveyance of the sheet.

2. The apparatus according to claim 1, wherein the display control unit is configured to display on the display device the features of the sheet and information whose content depends on the identification methods of the identified features.

3. The apparatus according to claim 1, wherein the display control unit is configured to separately display on the display device pieces of sheet information including the identified features of the sheet using the respective different identification methods.

4. The apparatus according to claim 1, wherein the identification methods of the features of the sheet by the identification unit further include a method for identifying a feature not identified based on the detection result of the detection unit as a feature of predetermined content.

5. The apparatus according to claim 1, wherein the display control unit is configured to display the sheet information on a screen on which at least one of registration and editing of a feature of the sheet is possible.

6. The apparatus according to claim 5,
wherein the display control unit is configured to, in a case where an operation for registering or editing a feature of the identified sheet using a predetermined identification method is performed, provide display configured to prompt confirmation as to whether registration or editing of the feature is needed, and
wherein the predetermined identification method includes an identification method based on the detection result of the detection unit.

7. The apparatus according to claim 5, wherein the display control unit is configured to, in a case where a feature of the sheet is changed by changing an identification method of the identified feature of the sheet, change a mode in which a piece of sheet information including the changed feature of the sheet is distinguished from another piece of sheet information based on the changed identification method.

8. The apparatus according to claim 1, further comprising a first prohibition unit configured to prohibit editing of a feature of the identified sheet using a predetermined identification method,
wherein the predetermined identification method includes an identification method based on the detection result of the detection unit.

9. The apparatus according to claim 1, further comprising a second prohibition unit configured to prohibit printing of a sheet for which the sheet information including at least one of a feature of the identified sheet using a predetermined identification method and a feature of the sheet whose content is confirmed by a user is not set,
wherein the predetermined identification method includes an identification method based on the detection result of the detection unit.

10. A printing apparatus comprising:
at least one memory storing instructions; and
at least one processor that, upon execution of the stored instructions, configures the at least one processor to operate as:
a feed unit configured to feed a sheet,
a printing unit configured to form an image on the sheet,
an identification unit configured to identify a feature of a sheet to be used for printing, and
a display control unit configured to display sheet information including the feature of the sheet on a display device,
wherein the display control unit is configured to display the sheet information including features of the sheet identified by the identification unit using respective different identification methods on the display device in a mutually distinguished manner, and
wherein the identification methods of the features of the sheet by the identification unit include an identification method based on a detection result of a detection unit configured to detect a physical quantity corresponding to a feature of the sheet during conveyance of the sheet.

11. A method comprising:
identifying a feature of a sheet to be used for printing; and
displaying sheet information including the feature of the sheet on a display device,
wherein the sheet information including features of the sheet identified using respective different identification methods is displayed on the display device in a mutually distinguished manner, and
wherein the identification methods of the features of the sheet include an identification method based on a detection result of a detection unit configured to detect a physical quantity corresponding to a feature of the sheet during conveyance of the sheet.

12. The method according to claim 11, further comprising displaying on the display device the features of the sheet and information whose content depends on the identification methods of the identified features.

13. The method according to claim 11, further comprising separately displaying on the display device pieces of sheet information including the identified features of the sheet using the respective different identification methods.

14. The method according to claim 11, wherein the identification methods of the features of the sheet by the identifying further include a method for identifying a feature not identified based on the detection result of the detection unit as a feature of predetermined content.

15. The method according to claim 11, further comprising displaying the sheet information on a screen on which at least one of registration and editing of a feature of the sheet is possible.

16. A non-transitory computer readable storage medium for storing a program causing a computer to execute a method, the method comprising:
identifying a feature of a sheet to be used for printing; and
displaying sheet information including the feature of the sheet on a display device,
wherein the sheet information including features of the sheet identified using respective different identification methods is displayed on the display device in a mutually distinguished manner, and
wherein the identification methods of the features of the sheet include an identification method based on a detection result of a detection unit configured to detect a physical quantity corresponding to a feature of the sheet during conveyance of the sheet.

17. The non-transitory computer readable storage medium according to claim 16, further comprising displaying on the display device the features of the sheet and information whose content depends on the identification methods of the identified features.

18. The non-transitory computer readable storage medium according to claim 16, further comprising separately displaying on the display device pieces of sheet information including the identified features of the sheet using the respective different identification methods.

19. The non-transitory computer readable storage medium according to claim 16, wherein the identification methods of the features of the sheet by the identifying further include a method for identifying a feature not identified based on the detection result of the detection unit as a feature of predetermined content.

20. The non-transitory computer readable storage medium according to claim 16, further comprising displaying the sheet information on a screen on which at least one of registration and editing of a feature of the sheet is possible.
